(19) United States
(12) Patent Application Publication
(10) Pub. No.: US 2023/0256528 A1
(43) Pub. Date: Aug. 17, 2023

(54) METHOD AND APPARATUS FOR USING A PORTABLE JOINER

(71) Applicant: Woodpeckers, LLC, Strongsville, OH (US)

(72) Inventor: Gregory L. SKILLICORN, Granger Township, OH (US)

(73) Assignee: Woodpeckers, LLC, Strongsville, OH (US)

(21) Appl. No.: 17/856,215

(22) Filed: Jul. 1, 2022

Related U.S. Application Data
(60) Provisional application No. 63/309,873, filed on Feb. 14, 2022.

(51) Int. Cl. B23D 59/00; G01B 3/56

(52) U.S. Cl. CPC B23D 59/001; G01B 3/56

(57) ABSTRACT

The present disclosure provides a joiner jig that is configured to be used with a Festool Domino tool. The joiner jig includes a base table adapted to operably engage with a joiner tool. The joiner jig also includes a fence operably engaged with the base table. The joiner jig also includes an adjustable protractor assembly selectively operably engaged with the base table and the fence. The adjustable protractor assembly is configured to be selectively pivotally adjustable to at least one predetermined angle from a range of angles.

### TECHNICAL FIELD

The present disclosure generally relates to a multipurpose tool for cutting mortises into a workpiece.

### BACKGROUND

Portable joiner tools and portable biscuit joiners are versatile tools that are used in multiple woodworking projects for drilling mortises into different types of workpiece, such as wood workpiece. Generally, portable joiner tools are used in woodworking projects for drilling and/or boring mortises for securing joints of furniture, doors, and casework via plunge-style circular saw. In this market, however, the Festool Domino joiner tool enables a woodworker to cut a full mortise into a workpiece with a single plunge by using a spinning and oscillating bit to cut a full mortise in a single plunge. With this technology, the mortises cut by the Festool Dominio enables a woodworker to use different types of tenons for joining various types of workpiece together for various woodworking projects as described above. While a woodworker may use a Festool Dominio to drill various types of mortises into various types of workpiece, it is difficult and demanding to drill precise and accurate mortises into a workpiece where the mortises must be drilled at various angles and/or be drilled at various orientations.

To address these difficulties and problems, a woodworker may select a device or multiple devices to help stabilize and guide his or her Festool Domino or other joiner tool during a woodworking project. While such assisting devices are provided in the market, the woodworker may have to use a number of different devices to drill different precise mortises into one or more types of workpiece. For example, the woodworker may have to use a first assisting device with the Festool Domino for drilling a first mortise with a first dimension (e.g., a support bracket) and a second assisting device with the Festool device for drilling a second mortise with a second dimension (e.g., cross stops). In another example, the woodworker may have to use a first set of assisting devices with the Festool Domino for drilling a first mortise that is located on a planar surface of a workpiece and a second set of assisting devices with the Festool Domino for drilling a second mortise that is located on an angled surface of a workpiece. Such use of multiple assisting devices requires the woodworker to have access to these various assisting devices and requires the expenditure of more time and effort when the woodworker is drilling multiple mortises into a workpiece with a Festool Domino.

### SUMMARY

In one aspect, an exemplary embodiment of the present disclosure may provide a joiner jig. The joiner jig has a base table adapted to operably engage with a joiner tool. The joiner jig also includes a fence operably engaged with the base table. The joiner jig also includes an adjustable protractor assembly operably engaged with the base table and the fence. The adjustable protractor is configured to be selectively pivotally adjustable to at least one predetermined angle from a range of angles provided by said adjustable protractor assembly. The adjustable protractor is also selectively positionable on the base table.

This exemplary embodiment or another exemplary embodiment may further provide that the adjustable protractor assembly comprises a fixed portion operably engaged with the base table; and a moveable portion operably engaged with the fixed portion; wherein the moveable portion is configured to selectively pivotally adjust to the at least one predetermined angle from the range of angles relative to the fixed portion. This exemplary embodiment or another exemplary embodiment may further provide that adjustable protractor assembly further comprises: a spacing gauge operably engaged with the fixed portion; wherein the spacing gauge is adapted to engage a spacer of the joiner tool to set the adjustable protractor at a predetermined distance from a range of distances provided by said spacing gauge. This exemplary embodiment or another exemplary embodiment may further provide a tool mounting assembly operably engaged with the base table; wherein the tool mounting assembly is adapted to operably engaged with the joiner tool to vertically move said joiner tool relative to the base table.

In another aspect, an exemplary embodiment of the present disclosure may provide a combination. The combination includes a joiner tool and a joiner jig adapted to operably engaged with the joiner tool. The joiner jig comprises a base table adapted to operably engage with a joiner tool; a fence operably engaged with the base table; and an adjustable protractor assembly operably engaged with the base table and the fence; wherein the adjustable protractor is configured to be selectively pivotally adjustable to at least one predetermined angle from a range of angles provided by said adjustable protractor assembly; and wherein the adjustable protractor is selectively positionable on the base table.

In another aspect, an exemplary embodiment of the present disclosure may provide a method of drilling at least one mortise into a workpiece with a joiner jig. The method comprises steps of: engaging a joiner tool with a base table of the joiner jig; engaging an adjustable protractor assembly of the joiner jig at a predetermined position with the base table of the joiner jig; positioning the adjustable protractor assembly at a predetermined distance relative to a drill bit of the joiner tool; pivoting a moveable portion of the adjustable protractor assembly of the joiner jig to a predetermined angle relative to a fixed portion of the adjustable protractor assembly; engaging the workpiece with the moveable portion of the adjustable protractor assembly; and drilling at least one mortise into the workpiece.

In yet another aspect, an exemplary embodiment of the present disclosure may provide a joiner jig. The joiner jig includes a base table adapted to operably engage with a joiner tool. The joiner jig also includes a fence operably engaged with the base table. The joiner jig also includes an adjustable protractor assembly selectively operably engaged with the base table and the fence. The adjustable protractor assembly is configured to be selectively pivotally adjustable to at least one predetermined angle from a range of angles.

This exemplary embodiment or another exemplary embodiment may further provide that the adjustable protractor assembly comprises a fixed portion operably engaged with the base table; and a moveable portion operably engaged with the fixed portion; wherein the moveable portion is configured to be selectively pivotally adjustable to the at least one predetermined angle from the range of angles relative to the fixed portion. This exemplary embodiment or another exemplary embodiment may further provide that the range of angles is from about 45 degrees up to about 90 degrees. This exemplary embodiment or another exemplary embodiment may further provide that the adjustable protractor assembly further comprises: a spacing gauge operably engaged with the fixed portion; wherein the spacing gauge is adapted to engage a drill stop of the joiner tool to set the adjustable protractor assembly at a predetermined distance away from the joiner tool from a range of distances enabled by the spacing gauge. This exemplary embodiment or another exemplary embodiment may further provide that the adjustable protractor assembly further comprises: at least one locking aperture defined in the fixed portion; a through-slot defined in the spacing gauge; and at least one connector operably engaged with the fixed portion, via the at least one locking aperture, and the spacing gauge, via the through-slot for selectively securing the spacing gauge with the fixed portion. This exemplary embodiment or another exemplary embodiment may further provide that when the at least one connector engages both the fixed portion and the spacing gauge, the spacing gauge is secured with the fixed portion at a predetermined position; and when the at least one connector engages the fixed portion and disengages the spacing gauge, the spacing gauge is freely moveable along the fixed portion. This exemplary embodiment or another exemplary embodiment may further provide that the base table further comprises: at least one set of adjustment threaded openings defined in the base table; wherein the adjustable protractor assembly is selectively positionable on the base table via the at least one set of adjustment threaded openings. This exemplary embodiment or another exemplary embodiment may further provide that the adjustable protractor assembly further comprises: an adjustment slot defined in the fixed portion; and a locking knob selectively engaged with the fixed portion and one of the at least one set of adjustment threaded openings for maintaining the adjustable protractor assembly at a range of predetermined positions along the base table. This exemplary embodiment or another exemplary embodiment may further provide that wherein when the locking knob engages both the fixed portion and one of the at least one set of adjustment threaded openings, the adjustable protractor assembly is secured at a predetermined position from the range of predetermined positions on the base table; and wherein when the locking knob disengages the fixed portion and engages one of the at least one set of adjustment threaded openings, the adjustable protractor assembly is freely moveable along the base table. This exemplary embodiment or another exemplary embodiment may further provide that the base table further comprises: at least one longitudinal T-shaped slot defined in the base table; and at least one transverse T-Shaped slot defined in the base table; wherein each of the at least one longitudinal T-shaped slot and the at least one transverse T-Shaped slot is adapted to receive at least one track clamp to enable the at least one track clamp and the base table to engage one another. This exemplary embodiment or another exemplary embodiment may further provide a tool mounting assembly operably engaged with the base table; wherein the tool mounting assembly is adapted to operably engaged with the joiner tool to vertically move the joiner tool relative to the base table. This exemplary embodiment or another exemplary embodiment may further provide that the tool mounting assembly comprises: a base plate operably engaged with the base table; at least one riser operably engaged with the base plate and extending from the base plate; a mount plate operably engaged with the at least one riser and moveable along the at least one riser; and at least one tube post operably engaged with the at least one riser and configured to receive the at least one riser; wherein the mount plate and the at one tube post are selectively secured at a desired position along the at least one riser relative to the base plate. This exemplary embodiment or another exemplary embodiment may further provide that the tool mounting assembly further comprises: a locking knob selectively engaged with the at least one riser and the at least one tube post; wherein when the locking knob is engaged with both the at least one riser and the at least one tube post, the mount plate and the at least one tube post are maintained at the desired position on the at least one riser; wherein when the locking knob is disengaged with the at least one riser and engaged the at least one tube post, the mount plate and the at least one tube post are freely moveably along the at least one riser. This exemplary embodiment or another exemplary embodiment may further provide that the tool mounting assembly further comprises: at least one biaser operably engaged with the at least one riser and the at least one tube post; wherein the at least one biaser biases the at least one tube post and the mount plate away from the at least one riser. This exemplary embodiment or another exemplary embodiment may further provide that the tool mounting assembly further comprises: at least one height limiting assembly operably engaged with the base plate and the mount plate; wherein the at least one height limiting assembly is configured to restrict vertical movement of the mount plate relative to the base plate. This exemplary embodiment or another exemplary embodiment may further provide an accessory releasably secured with the base plate; wherein the accessory is configured to hold a workpiece at a desired vertical angle relative to the joiner tool.

In yet another aspect, an exemplary embodiment of the present disclosure may provide a method of drilling at least one mortise into a workpiece with a joiner jig. The method comprises steps of engaging a joiner tool with a tool mounting assembly of the joiner jig; engaging an adjustable protractor assembly of the joiner jig at a predetermined position with a base table of the joiner jig; positioning the adjustable protractor assembly at a predetermined distance relative to a drill bit of the joiner tool; setting a moveable portion of the adjustable protractor assembly of the joiner jig to a predetermined angle relative to a fixed portion of the adjustable protractor assembly; engaging the workpiece with the moveable portion of the adjustable protractor assembly; and drilling at least one mortise into the workpiece.

This exemplary embodiment or another exemplary embodiment may further provide a step of setting a spacing gauge of the adjustable protractor assembly to space the adjustable protractor assembly at a distance away from the joiner jig. This exemplary embodiment or another exemplary embodiment may further provide steps of disengaging a locking knob of the tool mounting assembly from at least one riser of the tool mounting assembly; moving at least one tube post of the tool mounting assembly and a mount plate of the tool mounting assembly along the at least one riser to a desired position relative to the base table, wherein the joiner tool is operably engaged with the mount plate; engaging the locking knob with the at least one riser to maintain the mount plate at the desired position relative to the base table. This exemplary embodiment or another exemplary embodiment may further provide steps of positioning the adjustable protractor assembly in a first orientation relative to the base table; positioning the adjustable protractor assembly in a second orientation relative to the base table; wherein the second orientation is a mirrored orientation of the first orientation. This exemplary embodiment or another exemplary embodiment may further provide steps of disengaging an adjustment dial of the adjustable protractor assembly from an adjustment plate of the adjustable protractor assembly; pivoting the moveable portion away from the fixed portion to the predetermined angle; and reengaging the adjustment dial with the adjustment plate to maintain the predetermined angle.

### BRIEF DESCRIPTION OF THE SEVERAL VIEWS OF THE DRAWINGS

Sample embodiments of the present disclosure are set forth in the following description, are shown in the drawings and are particularly and distinctly pointed out and set forth in the appended claims.

FIG. 1 is a front, top, right side isometric perspective view of a joiner jig in accordance with one aspect of the present disclosure.

FIG. 2 is a top plan view of the joiner jig.

FIG. 3 is a right elevation view of the joiner jig.

FIG. 4 is left side elevation view of the joiner jig.

FIG. 5 is a front side elevation view of the joiner jig.

FIG. 6 is an exploded view of an adjustable protractor assembly of the joiner jig.

FIG. 7 is a partial transverse section view of the joiner jig taken in the direction of line 7- shown in FIG. 2.

FIG. 8 is a partial transverse section view of the joiner jig taken in the direction of line 8-8 shown in FIG. 2.

FIG. 9 is a partial longitudinal section view of a tool mounting assembly of the joiner jig taken in the direction of line 9-9 shown in FIG. 2.

FIG. 10A is an operational view of the joiner jig operatively engaged with a joiner tool and a first workpiece, wherein the adjustable protractor assembly is provided at a first orientation relative to a base table of the joiner jig, and wherein a moveable portion of the adjustable protractor is provided at a first angle relative to a fixed portion of the adjustable protractor.

FIG. 10B is an operational view of the joiner jig similar to FIG. 9A, but the adjustable protractor assembly is provided at a second mirrored orientation relative to the base table of the joiner jig.

FIG. 11A is an operational view of the joiner jig operatively engaged with a joiner tool, wherein the moveable portion of the adjustable protractor is provided at a second angle relative to the fixed portion of the adjustable protractor.

FIG. 11B is an operational view of the joiner jig similar to FIG. 10A, but the workpiece operably engages with the moveable portion of the adjustable protractor at the second angle.

FIG. 12 is a method of drilling at least one mortise into a workpiece with a joiner jig.

FIG. 13 is a partial longitudinal section view of another joiner jig in accordance with another aspect of the present disclosure.

FIG. 14 is a partial longitudinal section view of another joiner jig in accordance with another aspect of the present disclosure.

FIG. 15 is a front, top, right side perspective isometric view of an accessory.

FIG. 16 is an operational view of the accessory holding a workpiece at a vertical angle on another base plate of a joiner jig.

Similar numbers refer to similar parts throughout the drawings.

### DETAILED DESCRIPTION

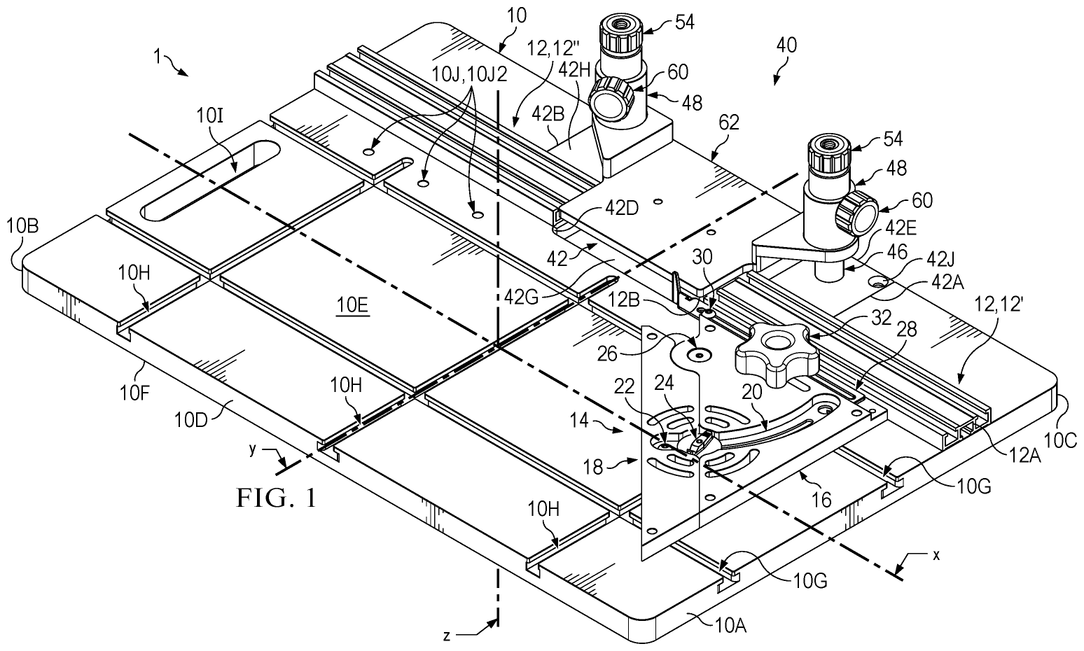

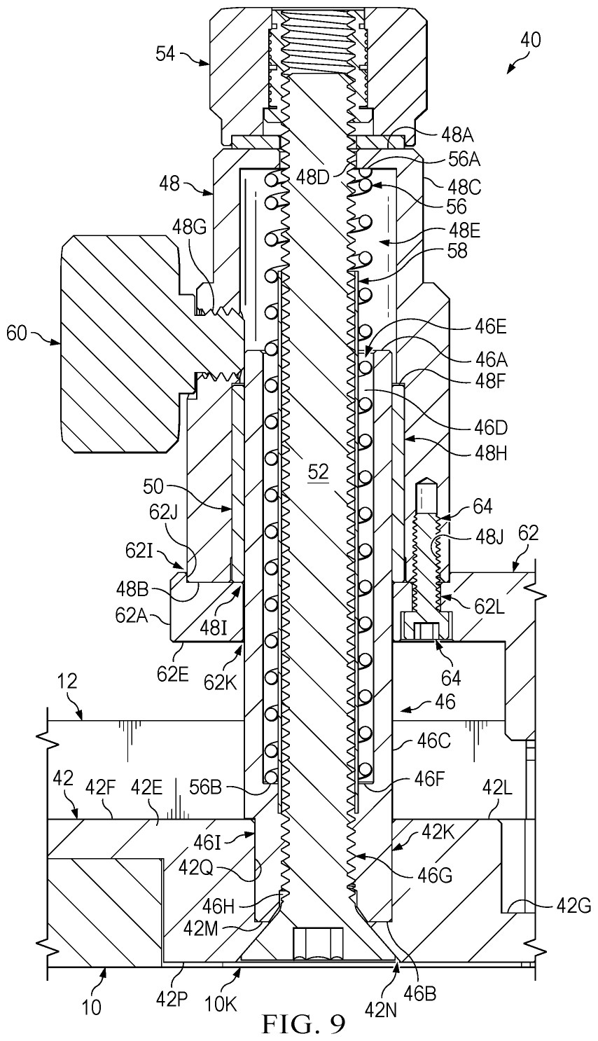

FIGS. 1-10B illustrate a joiner jig or an alignment joiner jig that is generally referred to as 1. As described in more detail below, the joiner jig 1 enables a woodworker to operatively engage a joiner tool 2 to enable the joiner tool 2 to cut and/or bore mortises and similar holes into a workpiece at a range of angles. Specifically, the joiner jig 1 enables a woodworker to operatively engage specific joiner tools with said joiner jig 1 (e.g., Festool Domino DF 500 and Festool Domino DF 700) to cut and/or bore mortises and similar holes into a workpiece at a range of angles. The joiner jig 1 also enables a woodworker to cut mortises into various types of workpiece defining various ranges of thickness, which is described in more detail below.

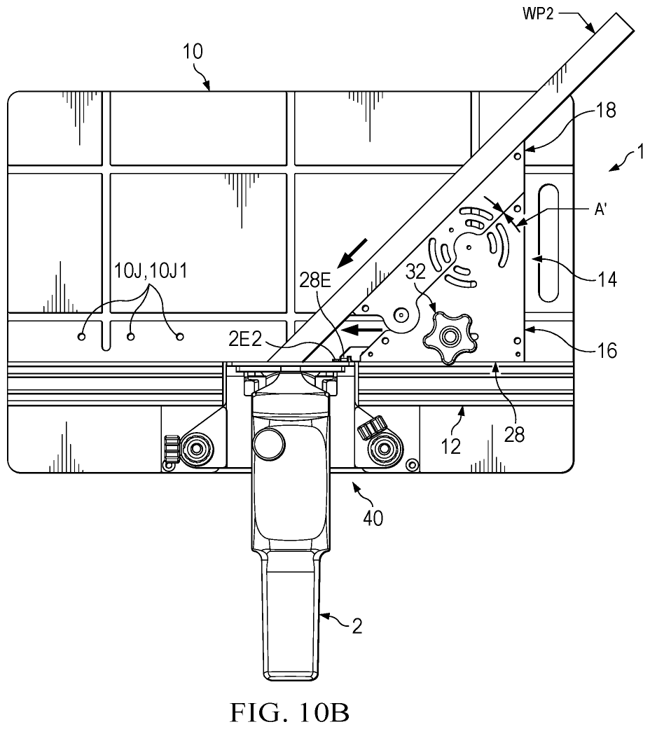

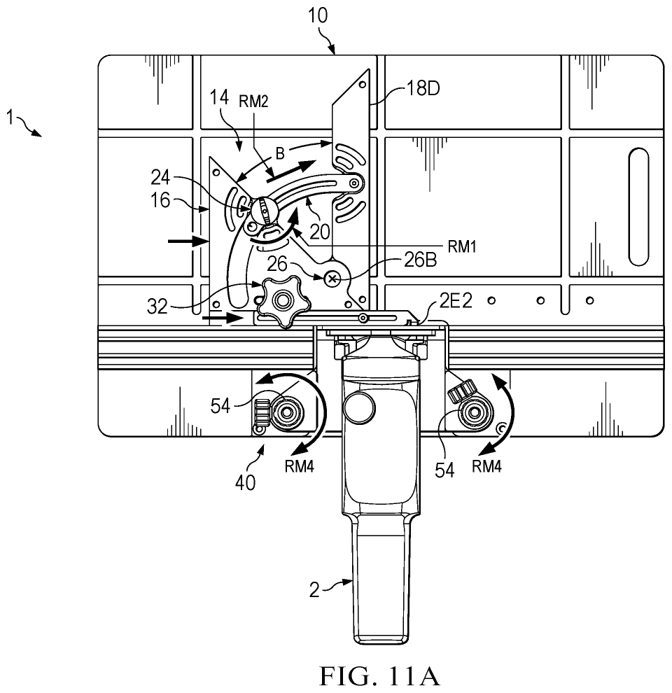

Referring to FIGS. 9A-10B, the joiner tool 2 includes a body 2A that holds and protects the mechanical assemblies and parts used to perform cutting and boring mortises into a workpiece. The joiner tool 2 also includes a base 2B that operably engages with the joiner jig 1 to maintain the joiner tool 2 with the joiner jig 1, which is described in more detail below. The joiner tool 2 also includes a front plate 2C defining a front opening 2D where the front plate 2C operably engages with the base 2B. The joiner tool 2 also includes a drill bit (not illustrated) that passes through the front opening 2D during drilling operations. The joiner tool 2 also includes at least one drill stop 2E positioned on the front plate 2C where the at least one drill stop 2E operably engages with a workpiece. In the illustrated embodiment, the joiner tool 2 includes a first drill stop 2E1 and an adjacent second drill stop 2E2 that are generally used to operably engaged a first outermost end and a second outermost end of a workpiece with the joiner tool 2.

As illustrated herein, the joiner tool 2 is a Festool Domino DF 500 that is operatively engaged with the joiner jig 1. As described in more detail below, the joiner jig 1 is configured to operably engage with specific Festool Domino tools, such as Festool Domino DF 500 and Festool Domino DF 700. In other exemplary embodiments, any suitable joiner tool may be operably engaged with the joiner jig 1 described and illustrated herein.

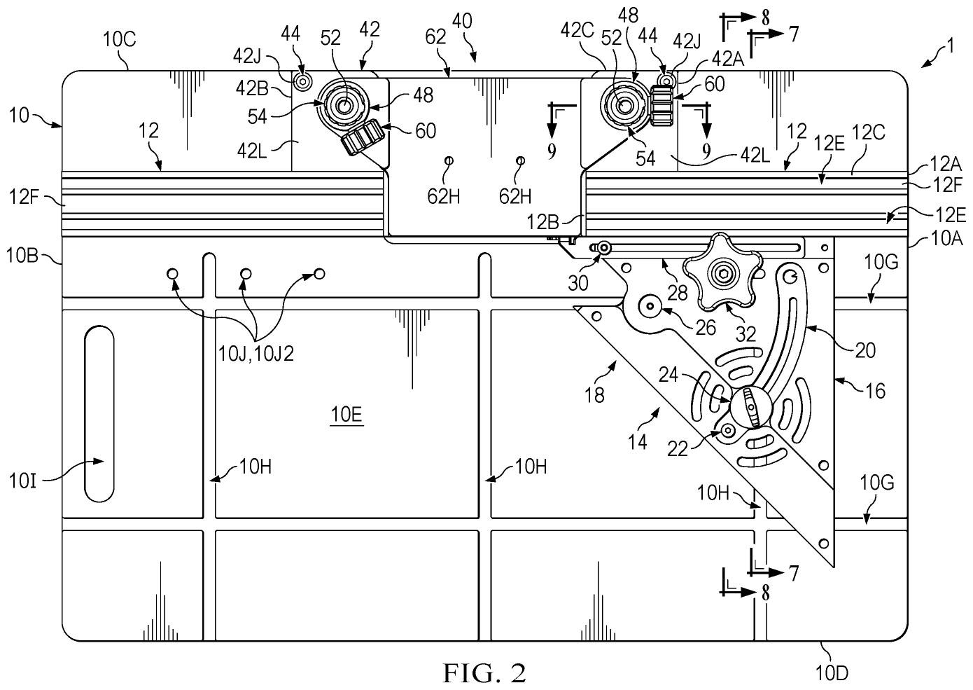

Referring to FIGS. 1 and 2, the joiner jig 1 includes a base table 10. The base table 10 has a first or front end 10A, a second or rear end 10B opposite to the rear end 10B, and a longitudinal axis “X” defined therebetween. The base table 10 also includes a first or left side 10C, a second or right side 10D opposite to the left side 10C, and a transverse axis “Y” defined therebetween. The base table 10 also includes a first or top surface 10E that extends between the front end 10A to the rear end 10B. The base table 10 also includes a second or bottom surface 10F that extends between the front end 10A to the rear end 10B and opposes the top surface 10E. The base table 10 also includes a vertical axis “Z” defined between the top surface 10E and the bottom surface 10F.

Referring to FIGS. 1-3, the base table 10 defines at least one longitudinal T-shaped slot 10G that extends between the front end 10A and the rear end 10B along an axis parallel with the longitudinal axis “X”. The at least one longitudinal T-shaped slot 10G extends downwardly into the base table 10 from the top surface 10E towards the bottom surface 10F. The base table 10 defines at least one transverse T-shaped slot 10H that extends between the left side 10C and the right side 10D along an axis parallel with the transverse axis “X”. The at least one transverse T-shaped slot 10H extends downwardly into the base table 10 from the top surface 10E towards the bottom surface 10F. As illustrated in FIGS. 1 and 2, the at least one transverse T-shaped slot 10H intersects the at least one longitudinal T-shaped slot 10G where the at least one longitudinal T-shaped slot 10G and the at least one transverse T-shaped slot 10H are in fluid communication with one another. While not illustrated herein, the at least one longitudinal T-shaped slot 10G and the at least one transverse T-shaped slot 10H are adapted to enable a woodworker to operably engage woodworking tools (e.g., clamps, etc.) with the base table 10 during drilling operations. As illustrated herein, the base table defines two longitudinal T-shaped slots 10G and three transverse T-shaped slot 10H.

While not illustrated herein, each of the at least one longitudinal T-shaped slot 10G and the at least one transverse T-shaped slot 10H is configured to receive conventional track clamps to enable the base table 10 to operably engage with conventional track clamps. A woodworker of the joiner jig 1 may use any suitable number of track clamps with a base table 10, via the at least one longitudinal T-shaped slot 10G and the at least one transverse T-shaped slot 10H, when clamping down at least one workpiece with the base table 10.

Referring to FIGS. 1-2, the base table 10 also defines a handle 101 proximate to the rear end 10B of the base table 10. The handle 101 extends entirely through the base table 10 where the top surface 10E and the bottom surface 10F are in fluid communication with one another at the handle 101. The handle 101 enables a woodworker to hold and grip the base table 10 at a single point when moving the joiner jig 1 during woodworking projects.

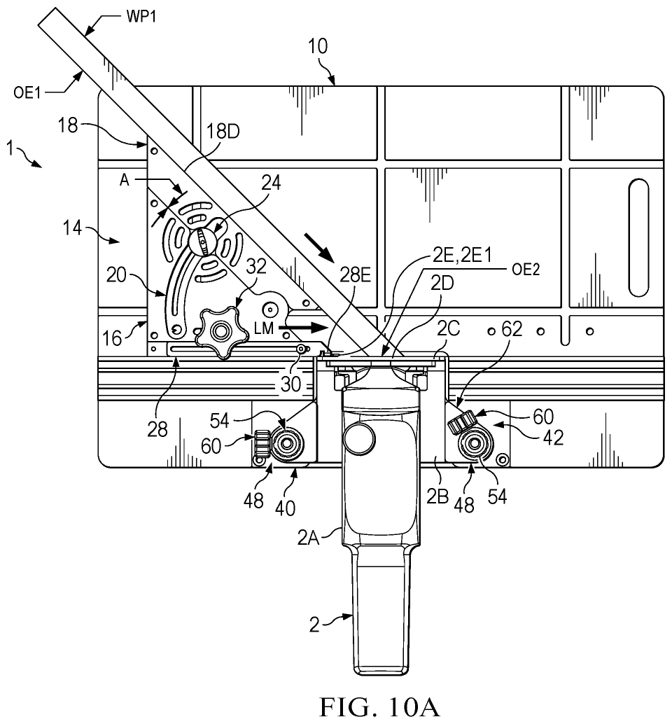

Still referring to FIGS. 1-2 and 7, the base table 10 defines at least one set of adjustment threaded openings 10J. The at least one set of adjustment threaded openings 10J extends entirely through the base table 10 where the top surface 10E and the bottom surface 10F are in fluid communication with one another at the at least one set of adjustment threaded openings 10J. Such use and purpose of the at least one set of adjustment threaded openings 10J is described in more detail below. As illustrated herein, the base table 10 defines a first set of adjustment threaded openings 10J1 where the first set of adjustment threaded openings 10J1 are defined proximate to the front end 10A of the base table 10 (see FIGS. 8 and 10B). As provided herein, the base table 10 defines a second set of adjustment threaded openings 10J2 where the second set of adjustment threaded openings 10J2 are defined proximate to the rear end 10B of the base table 10. Additionally, each of the first and second sets of adjustment threaded openings 10J1, 10J2 includes three adjustment threaded openings aligned with one another along an axis parallel with the longitudinal axis “X”.

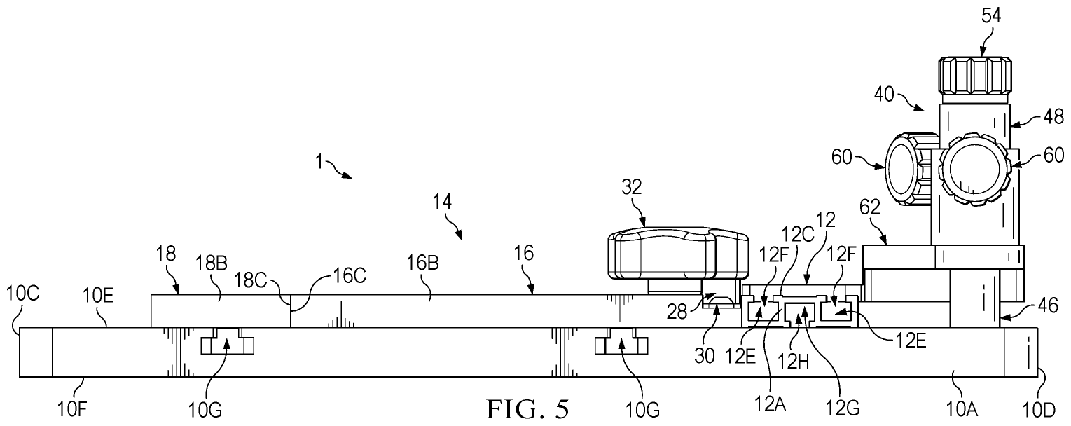

Referring to FIG. 4, the base table 10 also defines a notch 10K that transversely extends into the base table 10 from the left side 10C towards the right side 10D. Such use and purpose of the notch 10K is described in more detail below. The base table 10 also defines first and second recessed portions 10L1, 10L2 proximate to the left side 10C of the base table 10. The first and second recessed portions 10L1, 10L2 extend downwardly from the top surface 10E towards the bottom surface 10F and positioned inside of the notch 10K. The first recessed portion 10L1 is positioned proximate to the front end 10A of the base table 10, and the second recessed portion 10L2 is positioned proximate to the rear end 10B of the base table 10 opposite to the first recessed potion Such uses and purposes of the notch 10K and the first and second recessed portions 10L1, 10L2 are described in more detail below.

The base table 10 is made of a material that prevents damage and/or marring of a workpiece when said workpiece is operably engaged with the base table 10. Specifically, the base table 10 is made of a phenolic material that prevents damage and/or marring of a workpiece when said workpiece is operably engaged with the base table 10. In other exemplary embodiments, a base of a joiner jig may be made of any suitable material that prevents damage and/or marring of a workpiece when said workpiece is operably engaged with the base.

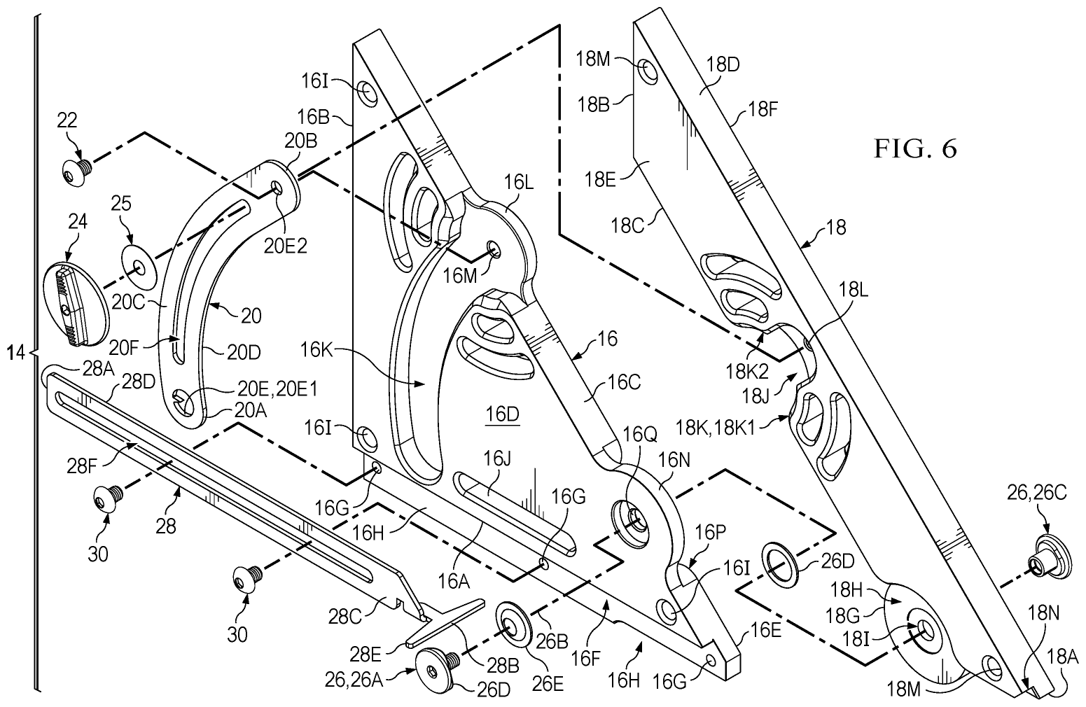

The joiner jig 1 also includes at least one fence 12 that operably engages with the base table 10. As illustrated in FIG. 2, at least one fence 12 includes a first or outer open end 12A, a second or inner open end 12B opposite to the outer end 12A, and a longitudinal axis defined therebetween parallel with the longitudinal axis “X”. As illustrated in FIG. 5, the at least one fence 12 also includes an upper wall 12C that extends between the outer end 12A and the inner end 12B along an axis parallel with the longitudinal axis “X”. The at least one fence 12 also includes a lower wall 12D that extends between the outer end 12A and the inner end 12B along an axis parallel with the longitudinal axis “X” and is opposite to the upper wall 12C. The at least one fence 12 defines at least one upper channel 12E that extends downwardly from the upper wall 12C to the lower wall 12D. The at least one upper channel 12E is also accessible via a slot 12F defined by the upper wall 12C and via the outer open end 12A. The at least one fence 12 defines at least one lower channel 12G that extends upwardly from the lower wall 12D to the upper wall 12C. The at least one lower channel 12G is also accessible via a slot 12H defined by the lower wall 12D and via the outer open end 12A. Such use and purpose of the at least one fence 12 is described in more detail below.

As illustrated herein, the joiner jig 1 includes a first fence 12′ disposed proximate to the front end 10A of the base table 10 and a second fence 12″ disposed proximate to the rear end 10B of the base table 10 opposite to the first fence 12′. The first and second fences 12′, 12″ are positioned adjacent to the joiner tool 2 where the inner ends 12B of the first and second fences 12′, 12″ are adjacent to the base 2B of the joiner tool 2. The first and second fences 12′, 12″ are identical to one another and are operably engaged with the base table 10 in a mirrored orientation.

The joiner jig 1 also includes an adjustable protractor assembly generally referred to as 14. The adjustable protractor assembly 14 is configured to be operably engaged with the base table 10 at at least one position on the base table 10 via the first and second sets of adjusted threaded openings 10J1, 10J2; such operable engagement between the base table 10 and the adjustable protractor assembly 14 is described in more detail below. The adjustable protractor assembly 14 is also configured to enable a woodworker to set the adjustable protractor assembly 14 at a predetermined angle from a range of angles to drill and/or bore at least one mortise into at least one workpiece; such use and purpose of setting angles via the adjustable protractor assembly 14 is described in more detail below.

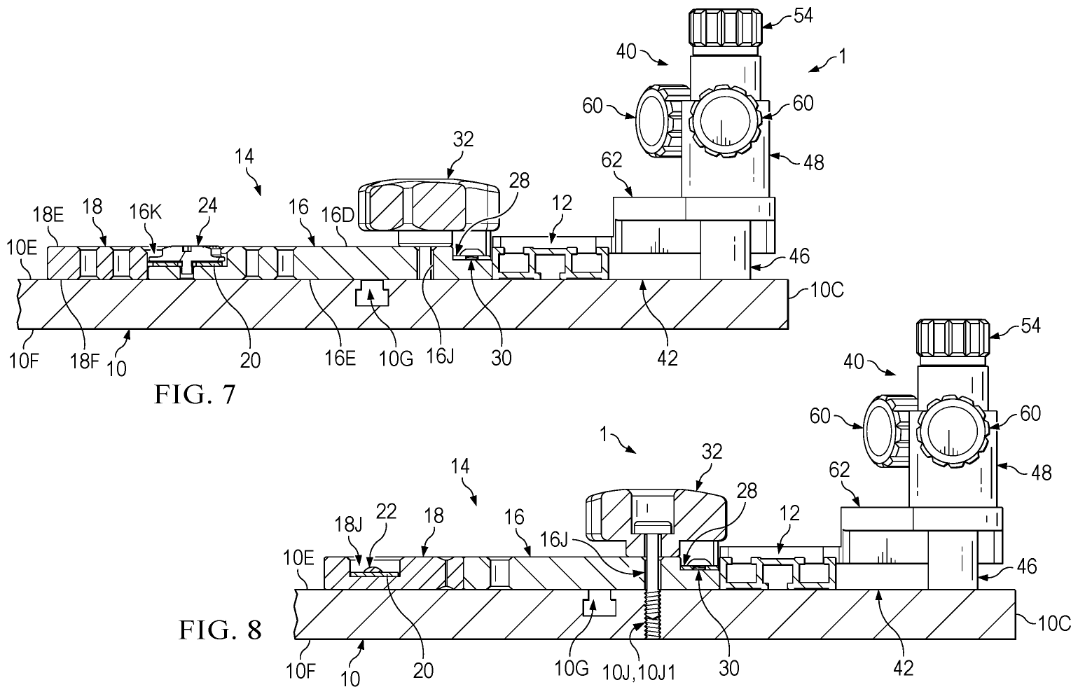

Referring to FIG. 6, the adjustable protractor assembly 14 includes a fixed portion 16. As described in more detail below, the fixed portion 16 operably engages with the base table 10 via one of the first and second sets of adjustment threaded openings 10J1, 10J2 (see FIGS. 8 and 10A-11B). The fixed portion 16 includes a first side 16A that operably engages with one of the first fence 12′ and the second fence 12″, a second side 16B orthogonal to the first side 16A, and a third or long side 16C that extends between the first side 16A and the second side 16B and that is adapted to operably engage with a workpiece. The fixed portion 16 also includes a first or top surface 16D that extends and is bound between the first, second, and third sides 16A, 16B, 16C. The fixed portion 16 also includes a second or bottom surface 16E that extends and is bound between the first, second, and third sides 16A, 16B, 16C and opposes the top surface 16D.

Still referring to FIG. 6, the fixed portion 16 defines a recessed portion 16F proximate to the first side 16A of the fixed portion 16. The recessed portion 16F extends downwardly into the fixed portion 16 from the top surface 16D towards the bottom surface 16E. The fixed portion 16 also defines at least one locking aperture 16G inside of the recessed portion 16F. The at least one locking aperture 16G also extends entirely through the recessed portion 16F from a top surface 16F1 of the recessed portion 16F to the bottom surface 16E of the fixed portion 16 where the top surface 16F1 and the bottom surface 16E are in fluid communication with one another via the at least one locking aperture 16G. Such use and purpose of the at least one locking aperture 16G is described in more detail below. As illustrated in FIG. 6, the fixed portion 16 defines three locking apertures 16G. The fixed portion 16 also defines an indent 16H that extends inwardly into the fixed portion 16 from the first side 16A towards the third side 16C; such use and purpose of the indent 16H is described in more detail below.

Still referring to FIG. 6, the fixed portion 16 also defines at least one attachment aperture 16I. The at least one attachment aperture 16I extends entirely through fixed portion 16 where the top surface 16D and the bottom surface 16E are in fluid communication via the at least one attachment aperture 16I. The at least one attachment aperture 16I is configured to receive an attachment device (e.g., a connector, a fastener, a bolt, etc.) to enable a woodworker to operably engage the fixed portion 16 with the base table 10 if desired by the woodworker. As illustrated herein, the fixed portion 16 defines three attachment apertures 16I.

Still referring to FIG. 6, the fixed portion 16 also defines an adjustment slot 16J. The adjustment slot 16J extends between the second and third ends 16B, 16C and is parallel with the first end 16A. The adjustment slot 16J extends entirely through fixed portion 16 where the top surface 16D and the bottom surface 16E are in fluid communication at the adjustment slot 16J. The adjustment slot 16J is configured to receive an attachment device (e.g., a connector, a fastener, a bolt, etc.) to enable a woodworker to operably engage the fixed portion 16 with the base table 10 via an opening of one of the first and second sets of adjustment threaded openings 10J1, 10J2. Such use and operation of the adjustment slot 16J is described in more detail below.

Still referring to FIG. 6, the fixed portion 16 defines a curvilinear or arcuate-shaped channel 16K that extends from the first side 16A to a lower or first protrusion 16L positioned at the third side 16C. The curvilinear channel 16K also extends downwardly into the fixed portion 16 from the top surface 16D towards the bottom surface 16E. Such use and purpose of the curvilinear channel 16K is described in more detail below. The lower protrusion 16L also extends outwardly from the third side 16C and defines a threaded pivot aperture 16M therein. As illustrated herein, the lower protrusion 16L is positioned proximate to the second side 16B of the fixed portion 16. Such uses and purposes of the lower protrusion 16L and the threaded pivot aperture 16M are also described in more detail below.

The fixed portion 16 also has an upper or second protrusion 16N that extends outwardly from the third side 16C. The upper protrusion 16N is adjacent with the upper protrusion 16N along the third side 16C where the upper protrusion 16N is positioned proximate to the first side 16A. The fixed portion 16 also defines a cavity 16P that extends upwardly from the bottom surface 16E to the upper protrusion 16N. The upper protrusion 16N also defines a pivot aperture 16Q that extends entirely through the upper protrusion 16N; such uses and purposes of the upper protrusion 16N and the pivot aperture 16Q are described in more detail below.

Still referring to FIG. 6, the adjustable protractor assembly 14 also includes a moveable portion 18 that is selectively pivotally adjustable relative to the fixed portion 16, which is described in more detail below. The moveable portion 18 includes a first angled side 18A, a second angled side 18B opposite to the first angle side 18A, and a longitudinal axis defined therebetween. The moveable portion 18 also includes a third or short side 18C, a fourth or long side 18D, and a transverse axis defined therebetween. The moveable portion 18 also includes a first or top surface 18E that extends and is bound by the first, second, third, and fourth sides 18A, 18B, 18C, and 18D. The moveable portion 18 also includes a second or bottom surface 18F that extends and is bound by the first, second, third, and fourth sides 18A, 18B, 18C, and 18D; the bottom surface 18F is also positioned opposite to the top surface 18E where the top and bottom surfaces 18E, 18F are facing in opposite directions.

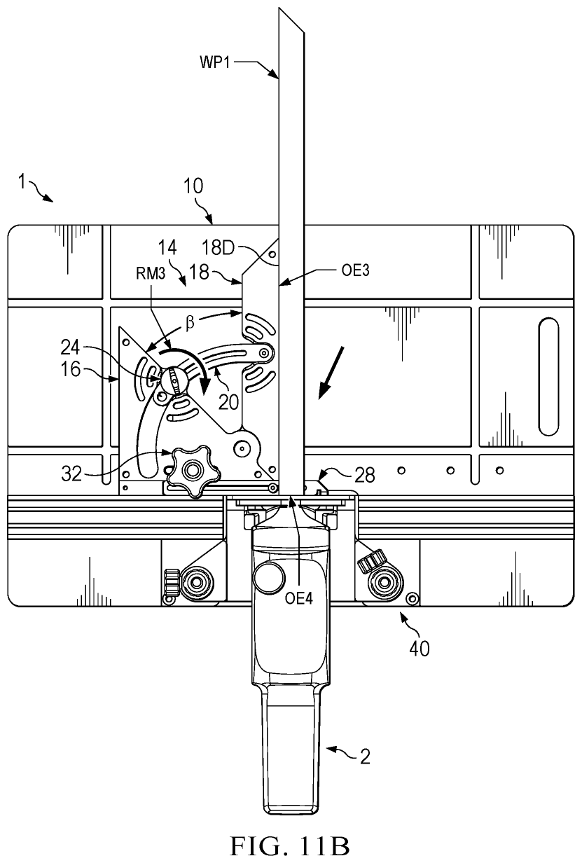

Still referring to FIG. 6, the moveable portion 18 also includes a projection 18G that extends outwardly from the third side 18C towards the fixed portion 16. The projection 18G is also positioned between the first and second angled ends 18A, 18B proximate to the first angled end 18A. The moveable portion 18 also defines a cavity 18H that extends downwardly into the moveable portion 18 from the top surface 18E to the projection 18G. The moveable portion 18 also defines a pivot opening 18I that extends entirely through the projection 18G therein; such use of the pivot opening 18I is described in more detail below. Upon assembly of the fixed portion 16 and the moveable portion 18, the projection 18G of the moveable portion 18 operably engages with the upper protrusion 16N of the fixed portion 16 via the upper protrusion 16N being received by the cavity 18H of the moveable portion 18. As described in more detail below, the projection 18G is rotatably moveable on the upper protrusion 16N when a woodworker selectively pivotally adjusts the moveable portion 18 relative to the fixed portion 16 (see FIG. 11A).

Still referring to FIG. 6, the moveable portion 18 also defines a channel 18J that extends and is bound from the third side 18C towards the fourth side 18D. The channel 18J also extends downwardly into the moveable portion 18 from the top surface 18E towards the bottom surface 18F. When the adjustable protractor assembly 14 is assembled, the channel 18J of the moveable portion 18 is aligned with the curvilinear channel 16K of the fixed portion 16 (as illustrated in FIGS. 1 and 2). The moveable portion 18 also defines a first rounded notch 18K1 that extends transversely into the moveable portion 18 from the third end 18C towards the fourth end 18D. The moveable portion 18 also defines a second rounded notch 18K2 that extends transversely into the moveable portion 18 from the third end 18C towards the fourth end 18D opposite to the first rounded notch 18K1. In the illustrated embodiment, the first rounded notch 18K1 is defined proximate the first angled end 18A and the second rounded notch 18K1 is defined proximate the second angled end 18B. When the adjustable protractor assembly 14 is assembled, the first and second rounded notches 18K1, 18K2 are configured to receive the lower protrusion 16L of the fixed portion 16 so that the fixed portion 16 and the moveable portion 18 may directly abut one another. The first and second rounded notches 18K1, 18K2 may receive other components of the adjustable protractor assembly 14 once the adjustable protractor assembly 14 is assembled, which is described in more detail below.

Still referring to FIG. 6, the moveable portion 18 also defines a threaded attachment opening 18L inside of the channel 18J. The threaded attachment opening 18L extends entirely through the moveable portion 18 inside of the channel 18J where bottom surface 18F of the moveable portion 18 is in fluid communication with the channel 18J via the threaded attachment opening 18L. Such use and purpose of the threaded attachment opening 18L is described in more detail below. Still referring to FIG. 6, the moveable portion 18 also defines at least one securement opening 18M proximate to the fourth side 18D. The at least one securement opening 18M also extends entirely through the moveable portion 18 where the top surface 18E and the bottom surface 18F are in fluid communication with one another at the at least one securement opening 18M. The at least one securement opening 18M allows a user to operably engage the moveable portion 18 with the base table 10 or another support structure with connectors (e.g., fasteners, bolts, etc.) via the at least one securement opening 18M. In the illustrated embodiment, the moveable portion 18 defines two securement openings 18M proximate to the fourth side 18D of the moveable portion 18.

Still referring to FIG. 6, the moveable portion 18 also defines a depressed portion 18N. The depressed portion 18 extends downwardly into the moveable portion 18 proximate to the point where the first angle end 18A and the long side 18D intersect with one another. Once the adjustable protractor assembly 14 is assembled, a section of the recessed portion 16F is received by the depressed portion 18N when the moveable portion 18 is pivoted relative to the fixed portion 16.

The adjustable protractor assembly 14 also includes an adjustment plate 20 that operably engages the fixed portion 16 and the moveable portion 18 with one another, which is described in more detail below. Additionally, the adjustment plate 20 enables a woodworker to move the moveable portion 18 relative to the fixed portion 16 to allow the joiner tool 2 to cut mortises at various angles into various types of workpiece, which is also described in more detail below.

Referring to FIG. 6, the adjustment plate 20 includes a first end 20A, a second end 20B opposite to the first end 20A, and a longitudinal direction defined therebetween (described in more detail below). The adjustment plate 20 also includes a top surface 20C that extends between and is bound by the first and second ends 20A, 20B. The adjustment plate 20 also includes a bottom surface 20D that extends between and is bound by the first and second ends 20A, 20B; the bottom surface 20D opposes the top surface 20C. As illustrated in FIG. 2, the adjustment plate 20 is configured to be received by the curvilinear channel 16K of the fixed portion 16 and the channel 18J of the moveable portion 18 due to the shaped of the adjustment plate 20 being complementary to the curvilinear channel 16K and the channel 18J.

Still referring to FIG. 6, the adjustment plate 20 defines at least one attachment hole 20E at one or both of the first end 20A and the second end 20B. The at least one attachment hole 20E also extends entirely through the adjustment plate 20 where the top surface 20C to the bottom surface 20D are in fluid communication via the at least one attachment hole 20E. As illustrated in FIG. 6, the adjustment plate 20 defines a first attachment hole 20E1 proximate to the first end 20A and a second attachment hole 20E2 proximate to the second end 20B; such use and purpose of each attachment hole 20E1, 20E2 is described in more detail below.

Still referring to FIG. 6, the adjustment plate 20 also defines an adjustment curvilinear or arcuate-shaped slots 20F. The adjustment curvilinear slot 20F extends along the longitudinal direction of the adjustment plate 20 between the first end 20A and the second end 20B. The adjustment curvilinear slot 20F also extends entirely through the adjustment plate 20 where the top surface 20C and the bottom surface 20D are in fluid communication with one another via the adjustment curvilinear slot 20F. The adjustment curvilinear slot 20F is also separate from the first attachment hole 20E1 and the second attachment hole 20E2. Such securement and support with the fixed portion 16 and the moveable portion 18 is described in more detail below.

The adjustment curvilinear slot 20F also provides a range of angles that enables a woodworker to pivot and/or rotate the moveable portion 18 to a desired angle from the range of angles relative to the fixed portion 16. In the illustrated embodiment, the range of angles defined by the adjustment curvilinear slot 20F enables a woodworker to pivot the moveable portion 18 from about 45 degrees (see FIGS. 1-2 and FIG. 10A) up to about 90 degrees (see FIG. 11A) relative to the fixed portion 16. While not illustrated herein, the adjustment curvilinear slot 20F may include indicia or measurement markings indexing the the range of angles to assist the woodworker in selecting a desired angle during woodworking projects.

Still referring to FIG. 6, the adjustable protractor assembly 14 also includes a connector 22. The connector 22 operably engages the adjustment plate 20 with the moveable portion 18 by threadably engaging with the threaded attachment opening 18L.

Still referring to FIG. 6, the adjustable protractor also includes an adjustment dial 24. The adjustment dial 24 operably engages the adjustment plate 20 with the fixed portion 16 by threadably engaging with the threaded pivot aperture 16M. During operation, the adjustment dial 24 may be tightened against the top surface 20C of the adjustment plate 20 by a woodworker to maintain the position of the moveable portion 18 relative to the fixed portion 16. Additionally, the adjustment dial 24 may be loosened from the adjustment plate 20 by a woodworker to enable said woodworker to pivot or rotate the moveable portion 18 to a desired degree from the range of degrees defined by the adjustment curvilinear slot 20F relative to the fixed portion 16. Additionally, a flat washer 25 may be operably engaged between the adjustment dial 24 and the adjustment plate 20.

Still referring to FIG. 6, the adjustable protractor assembly 14 also includes a pivot securement mechanism 26 that operably engages the fixed portion 16 and the moveable portion 18 with one another. The pivot securement mechanism 26 includes a connector 26A that is received by the pivot aperture 16Q of the fixed portion 16 and the pivot opening 18I of the moveable portion 18. The connector 26A operably engages the fixed portion 16 and moveable portion 18 with one another at the upper protrusion 16N and the projection 18G. During operation, the moveable portion 18 rotates about a longitudinal axis 26B of the connector 26A when rotated by a woodworker. The pivot securement mechanism 26 also includes a pivot nut 26C that threadably engages with the connector 26A to maintain the fixed portion 16 and the moveable portion 18 with one another. The pivot securement mechanism 26 also includes a curve washer 26D that operably engages between the connector 26A and the pivot nut 26C. The pivot securement mechanism 26 also includes a flat washer 26E that operably engages with the connector 26A and the pivot nut 26C.

The adjustable protractor assembly 14 also includes a spacing gauge 28. The spacing gauge 28 operably engages with the recessed portion 16F of the fixed portion 16; such engagement of the spacing gauge 28 with the fixed portion 16 is described in more detail below. Referring to FIG. 6, the spacing gauge 28 includes a first end 28A, a second end 28B that is opposite to the first end 28A, and a longitudinal axis defined therebetween. The spacing gauge 28 also includes a top surface 28C bound between the first and second ends 28A, 28B, and a bottom surface 28D also bound between the first and second ends 28A, 28B opposite to the top surface 28C.

Still referring to FIG. 6, the spacing gauge 28 also includes a stopper 28E at the first end 28A of the spacing gauge 28. The stopper 28E enables a woodworker to set the adjustable protractor assembly 14 at a desired distance from the drill bit where the stopper 28E abuts one of the drill stops 2E1, 2E2 provided on the joiner tool 2. The spacing gauge 28 also defines a through-slot 28F that extends entirely through the spacing gauge 28 where the top surface 28C and the bottom surface 28D are in fluid communication with one another via the through-slot 28F. The spacing gauge 28 also defines a range of distances (not illustrated) to enable a woodworker to select a desired distance of spacing between the joiner tool 2 and the adjustable protractor assembly 14. In the illustrated embodiment, the range of distances defined by the spacing gauge 28 from about zero inches up to about twelve inches. While not illustrated herein, a spacing gauge may define indicia or measurement markings for a range of distances defined by the spacing gauge to assist the woodworker in setting a desired distance between an adjustable protractor and a joiner tool.

The adjustable protractor assembly 14 also includes at least one connector 30. The at least one connector 30 is received by the through-slot 28F and threadably engages with the at least one locking aperture 16G to operably engage the spacing gauge 28 with the fixed portion 16. During operation, the head of the at least one connector 22 may be loosened from the top surface 28C of the spacing gauge 28 to allow the spacing gauge 28 to move longitudinally along the first side 16A of the fixed portion 16 to allow a woodworker to set a desired distance between the drill bit of the joiner tool 2 and the adjustable protractor assembly 14. The head of the at least one connector 30 may also be tightened against the top surface 28C of the spacing gauge 28 to secure the spacing gauge 28 with the fixed portion 16 to maintain the desired distance between the drill bit of the joiner tool 2 and the adjustable protractor assembly 14.

The adjustable protractor assembly 14 also includes a locking knob 32. As illustrated in FIG. 8, the locking knob 32 operably engages the fixed portion 16 with the base table 10. Specifically, the locking knob 32 is received by the adjustment slot 16J and threadably engages with an adjustment threaded openings of one of the first set of adjustment threaded openings 10J1 and the second set of adjustment threaded openings 10J2 to operably engage the fixed portion 16 with the base table 10. As illustrated in FIG. 8, the locking knob 32 threadably engages with an adjustment threaded opening of the first set of adjustment threaded openings 10J1. In other instances, the locking knob 32 may threadably engages with an adjustment threaded opening of the second set of adjustment threaded openings 10J2 to operably engage the fixed portion 16 at a different mirrored position on the base table 10 (see FIG. 10B).

During operation, the locking knob 32 may be loosened from the fixed portion 16 to allow the fixed portion 16 and other components operably engaged with the fixed portion 16 to move longitudinally along the base table 10 via the adjustment slot 16J. Such longitudinal movement allows a woodworker to select a desired distance to position the fixed portion 16 and other components operably engaged with the fixed portion 16 relative to the joiner tool 2. Once a desired distance is selected, the woodworker may then secure the locking knob 32 against the fixed portion 16 to restrict movement of the fixed portion 16 and other components operably engaged with the fixed portion 16.

The joiner jig 1 also includes a tool mounting assembly 40 that is operably engaged with the base table 10. The tool mounting assembly 40 is configured to enable a woodworker to operably engage the joiner tool 2 with the joiner jig 1. The tool mounting assembly 40 is also configured to vertically move the joiner tool 2 upwardly and downwardly relative to the base table 10 for drilling mortises and other holes into various types of workpiece with different thicknesses. In the illustrated embodiment, the tool mounting assembly 40 allows the joiner tool 2 to drill a mortise into various types of workpiece having a thickness from about ten millimeters up to about fifty millimeters.

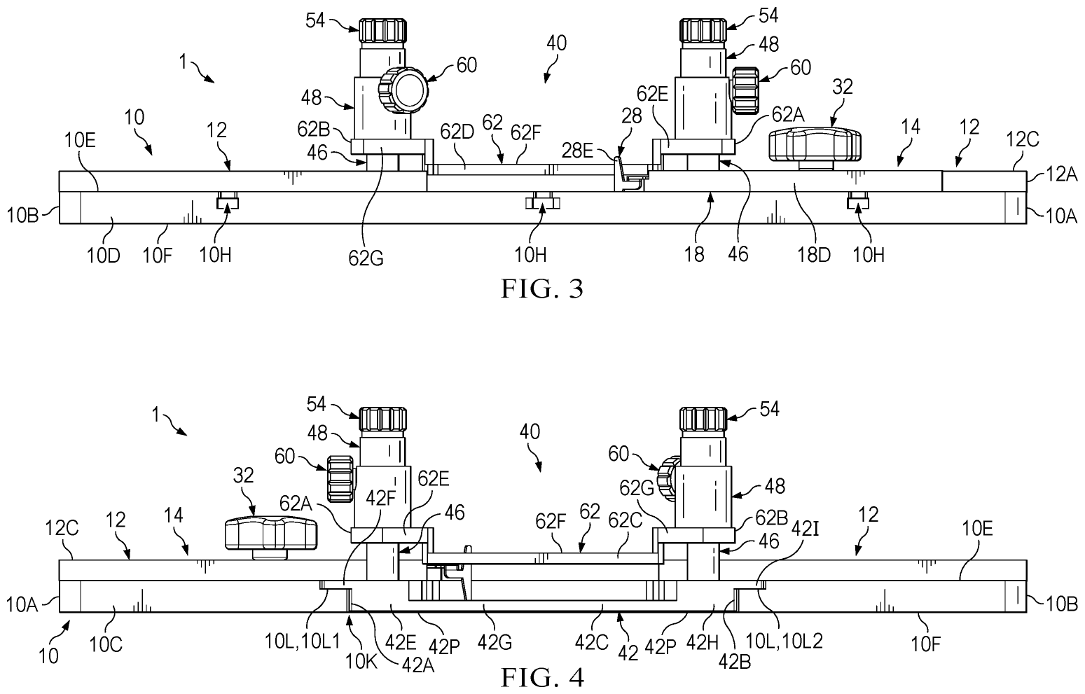

The tool mounting assembly 40 includes a base plate 42. The base plate 42 operably engages with the base table 10 inside of the notch 10K and the recessed openings 10L1, 10L2, which is described in more detail below. As illustrated in FIG. 4, the base plate 42 includes a first end 42A, a second end 42B opposite to the first end 42A, and a longitudinal axis defined therebetween. The base plate 42 also includes a first side 42C (see FIG. 3), a second side 42D opposite to the first side 42C, and a transverse axis defined therebetween. Still referring to FIG. 4, the base plate 42 includes a first foot 42E that extends from the first end 42A towards the second end 42B. The base plate 42 also includes a first lip 42F extends longitudinally away from the first end 42A and away from the first foot 42E towards the first end 10A of the base table 10. The base plate 42 also includes a platform 42G that extends from the first foot 42E to a second foot 42H of the base plate 42. The second foot 42H extends from the second end 42B to the platform 42G. The base plate 42 also includes a second lip 421 that extends longitudinally away from the second end 42B and away from the second foot 42H towards the rear end 10B of the base table 10. As illustrated in FIG. 4, the first lip 42F and the second lip 421 operably engage with the base table 10 inside of the recessed openings 10L1, 10L2 where the base plate 42 is held inside of the base table 10.

Referring to FIG. 2, the base plate 42 also defines attachment holes 42J. The attachment holes 42J extend entirely through the base plate 42 in one or both of the first lip 42F and the second lip 421. As illustrated in FIG. 2, at least one attachment hole 42J is defined in the first lip 42F and at least another attachment hole 42J is defined in the second lip 421. Such uses and purposes of the attachment holes 42J are described in more detail below.

Referring to FIG. 9, the base plate 42 also defines at least one riser cavity 42K. The at least one riser cavity 42K extends into the base plate 42 in one of the first foot 42E and the second foot 42H. Specifically, the at least one riser cavity 42K extends from a top surface 42L of one of the first foot 42E and the second foot 42H to an interior shoulder 42M. In the illustrated embodiment, the base plate 42 defines a riser cavity 42K in the first foot 42E and another riser cavity 42K in the second foot 42H.

Still referring to FIG. 9, the base plate 42 also defines at least one riser through-hole 42N where the at least one riser through-hole 42N extends into the base plate 42 in one of the first foot 42E and the second foot 42H. Specifically, the at least one riser through-hole 42N extends from the interior shoulder 42M to a bottom surface 42P of one of the first foot 42E and the second foot 42H. In the illustrated embodiment, the base plate 42 defines a riser through-hole 42N in the first foot 42E and another riser through hole 42N in the second foot 42H.

The base plate 42 also includes a planar interior wall 42Q inside each foot 42E, 42H. Each planar interior wall 42Q that extends downwardly from the top surface 42L of each foot 42E, 42H to the interior shoulder 42M of each foot 42E, 42H. The planar interior wall 42Q is positioned orthogonal to the interior shoulder 42M of each foot 42E, 42H. Such use and purpose of the planar interior wall 42Q inside each foot 42E, 42H is described in more detail below.

The tool mounting assembly 40 also includes connectors 44. As illustrated in FIG. 2, the connectors 44 are received by the attachment holes 42J and threadably engage with threaded opening (not illustrated herein) defined in the base table 10 to secure the base plate 42 with the base table 10. In other exemplary embodiments, any suitable mechanism may be used to operably engage the base plate 42 with the base table 10.

The tool mounting assembly 40 also includes at least one riser 46. As illustrated in FIG. 9, the at least one riser 46 operably engages with the base plate 42 inside of the at least one riser cavity 42K. In the illustrated embodiment, the tool mounting assembly 40 includes two risers 46 that operably engages with the first foot 42E of the base plate 42 and with the second foot 42H of the base plate 42. The two risers 46 are substantially similar to one another and operably engaged with the base plate 42 in the same orientation. Inasmuch as the risers 46 are substantially similar to one another, the following description will relate to the riser 46 operably engaged with the first foot 42E of the base plate 42. It should be understood, however, that the description of the riser 46 operably engaged with the first foot 42E applies substantially equal to the riser 46 operably engaged with the second foot 42H of the base plate 42.

Referring to FIG. 9, the riser 46 includes a first or upper end 46A, a second or lower end 46B that is opposite to the upper end 46A, a circumferential wall 46C extending between the upper and lower ends 46A, 46B, and a longitudinal axis defined therebetween. The riser 46 defines an upper passageway 46D that extends from an upper opening 46E defined at the upper end 46A to a shoulder 46F positioned between the upper end 46A and the lower end 46B. The riser 46 also defines a lower threaded passageway 46G that extends from the shoulder 46F to a lower opening 46H defined at the lower end 46B of the riser 46. The riser 46 also defines an indentation 461 that extends radially into the riser 46 proximate to the lower end 46B of the riser 46. The indentation 461 provides a locking mechanism between the riser 46 and the base plate 42 to prevent rotation or movement of the riser 46 about the longitudinal axis of the riser 46 during operation. Specifically, the indentation 461 enables a portion of the circumferential wall 46C to operably engage with the planar interior wall 42Q of a foot 42E, 42H of the base plate 42 to prevent rotation or movement of the riser 46 about the longitudinal axis of the riser 46 during operation.

The tool mounting assembly 40 also includes at least one tube post 48. As illustrated in FIG. 9, the at least one tube post 48 is operably engaged with the at least one riser 46 and is disposed about the at least one riser 46. In the illustrated embodiment, the tool mounting assembly 40 includes two tube posts 48 that operably engages with the two risers 46 described above. The two tube posts 48 are substantially similar to one another and are operably engaged with the two risers 46 in the same orientation. Inasmuch as the tube posts 48 are substantially similar to one another, the following description will relate to the tube post 48 operably engaged with the riser 46 that is operably engaged with the first foot 42E. It should be understood, however, that the description of the tube post 48 operably engaged with the first riser 46 inside of the first foot 42E applies substantially equal to the tube post 48 operably engaged with the second riser 46 that is operably engaged with the second foot 42H.

Referring to FIG. 9, the tube post 48 includes a first or upper end 48A, a second or lower end 48B opposite to the upper end 48A, a circumferential wall 48C extending between the upper and lower ends 48A, 48B, and a longitudinal axis defined therebetween that is parallel with the longitudinal axis of the riser 46. The tube post 48 defines an upper aperture 48D at the upper end 48A of the tube post 48. The tube post 48 also defines an upper passage 48E that extends from the upper aperture 48D to an interior shoulder 48F. The tube post 48 also defines a side threaded passageway 48G that extends into the circumferential wall 48C along an axis orthogonal to the longitudinal axis of the tube post 48; such use and purpose of the side threaded passageway 48G is described in more detail below.

Still referring to FIG. 9, the tube post 48 defines a lower passage 48H that extends from the interior shoulder 48F to a lower aperture 481 defined at the lower end 48B of the tube post 48. The tube post 48 also defines at least one vertical threaded passageway 48J that extends into the tube post 48 from the lower end 48B towards the upper end 48A. The at least one vertical threaded passageway 48J is separate from the upper passage 48E and the lower passage 48H. Such use and purpose of the at least one vertical threaded passageway 48J is described in more detail below.

The tool mounting assembly 40 also includes a bunting bearing 50 that operably engages with each riser 46 and each tube post 48. As illustrated in FIG. 9, the bunting bearing 50 operably engages about a portion of the riser 46 and operably engages with the tube post 48 inside of the lower passage 48H. Specifically, the bunting bearing 50 also operably engages with the interior shoulder 48F of the tube post 48 inside of the lower passage 48H. The bunting bearing 50 is configured to reduce friction between the riser 46 and the tube post 48 to allow the tube post 48 to move longitudinally along the riser 46 for raising or lowering the joiner tool 2 during a woodworking project.

The tool mounting assembly 40 also includes bolt 52 that operably engages with each riser 46. Referring to FIG. 9, the bolt 52 is configured to threadably engage with the lower threaded passageway 46G of the riser 46 to secure the riser 46 with the base plate 42. Once the riser 46 is secured, the bolt 52 is housed inside of the riser 46 and the tube post 48 where a portion of the bolt 52 is disposed outside of the tube post 48 proximate to the upper end 48A.

The tool mounting assembly 40 also includes a micro-adjusting knob 54. Referring to FIG. 9, the micro-adjusting knob 54 is positioned at the upper end 48A of the tube post 48 and threadably engages with the bolt 52 that is positioned outside of the tube post 48; such use and purpose of the micro-adjusting knob 54 is described in more detail below.

The tool mounting assembly 40 also includes a biaser 56. Referring to FIG. 9, the biaser 56 includes an upper end 56A, a lower end 56B opposite to the upper end 56A, and a longitudinal axis defined therebetween. As illustrated in FIG. 9, a portion of the biaser 56 from the upper end 56A towards the lower end 56B is positioned inside of the upper passageway 46D of the riser 46. Additionally, another portion of the biaser 56 from the lower end 56B towards the upper end 56A is positioned inside of the upper passage 48E of the tube post 48. Additionally, the upper end 56A of the biaser 56 operably engages with the circumferential wall 48C of the tube post 48 at the upper end 48A. The lower end 56B of the biaser 56 also operably engages with the shoulder 46F of the riser 46. The biaser 56 is also positioned circumferentially about the bolt 52. Such use and purpose of the biaser 56 is described in more detail below.

The tool mounting assembly 40 also includes a biaser tube 58. Referring to FIG. 9, the biaser tube 58 surrounds the bolt 52 and is positioned inside of the biaser 56 between the upper and lower ends 56A, 56B. Still referring to FIG. 9, the biaser tube 58 also operably engages with the riser 46 proximate to the shoulder 46F. As illustrated herein, the biaser tube 58 separates the biaser 56 from the bolt 52 to prevent the bolt 52 and the biaser 56 from interfering with one another during operation.

The tool mounting assembly 40 also includes a locking knob 60. Referring to FIG. 9, the locking knob 60 threadably engages with the tube post 48 via the side threaded passageway 48G. During operation, the locking knob 60 may operably engage with the riser 46 to hold and lock the riser 46 at a desired position relative to the tube post 48, which is described in more detail below.

The tool mounting assembly 40 also includes a mount plate 62. Referring to FIGS. 4 and 9, the mount plate 62 includes a first end 62A, a second end 62B opposite to the first end 62A, and a longitudinal axis defined therebetween. The mount plate 62 also includes a first side 62C, a second side 62D opposite to the first side 62C (see FIG. 3), and a transverse axis defined therebetween. The mount plate 62 also includes a first arm 62E that extends from the first end 62A towards a platform 62F. The mount plate 62 also includes a second arm 62G that extends from the second end 62B towards the platform 62F where the second arm 62G is opposite to the first arm 62E. The platform 62F of the mount plate 62 is positioned vertically below the first arm 62E and the second arm 62G. As illustrated in FIG. 4, the structural configuration of the mount plate 62 is complementary to the structural configuration of the base plate 42 so that the mount plate 62 may be housed inside of the base plate 42 for cutting thinner types of workpiece for certain woodworking projects, which is described in more detail below.

Referring to FIGS. 1 and 2, the mount plate 62 defines attachment threaded holes 62H. Specifically, the attachment threaded holes 62H are defined in the platform 62F to allow connectors (not illustrated) to pass through the attachment threaded holes 62H so such connectors operably engage the joiner tool 2 with the mount plate 62. In other exemplary embodiments, any suitable connection mechanism may be used to operably engage a joiner tool with a mount plate of a tool mounting assembly.

The mount plate 62 also defines a tube post cavity 621 in each of the first arm 62E and the second arm 62G. As illustrated in FIG. 9, the tube post cavity 621 defined in the first arm 62E extends downwardly into the first arm 62E to an inner shoulder 62J. Still referring to FIG. 9, a portion of the respective tube post 48 and a portion of the respective bunting bearing 50 are received by the tube post cavity 621 in the first arm 62E. Additionally, the lower end 48B of the tube post 48 and bunting bearing 50 operably engage with the inner shoulder 62J inside of the tube post cavity 621 of the first arm 62E. Such configuration of the tube post cavity 621 and the inner shoulder 62J of the second arm 62G is substantially similar to the tube post cavity 621 and the inner shoulder 62J of the first arm 62E.

The mount plate 62 also defines a tube post through-hole 62K in each of the first arm 62E and the second arm 62G. As illustrated in FIG. 9, the tube post through-hole 62K defined in the first arm 62E extends downwardly from the inner shoulder 62J where the riser 46 and the mount plate 62 operably engaged with one another inside of the tube post through-hole 62K. Such configuration of the tube post through-hole 62K of the second arm 62G is substantially similar to the tube post through-hole 62K of the first arm 62E.

The mount plate 62 also defines at least one lower through-hole 62L in each of the first arm 62E and the second arm 62G. As illustrated in FIG. 9, the at least one lower through-hole 62L defined in the first arm 62E extends vertically through the first arm 62E. The at least one lower through-hole 62L defined in the first arm 62E is coaxial with the at least one vertical threaded passageway 48J of the tube post 48. Such alignment of the at least one lower through-hole 62L and the at least one vertical threaded passageway 48J allows a fastener 64 to be received by the mount plate 62 and to threadably engage with the at least one vertical threaded passageway 48J. Such engagement by the fastener 64 operably engages the tube post 48 and the first arm 62E of the mount plate 62 with one another. Such configuration of the at least one lower through-hole 62L defined in the second arm 62G is substantially similar in operably engaging the tube post 48 and the second arm 62G of the mount plate 62 with one another via a fastener 64.

During operation, the joiner jig 1 enables a woodworker to cut at least one mortise into various types of workpiece with varying thickness. In the illustrated embodiment, the joiner jig 1 enables the joiner tool 2 to cut a mortise in the center of a workpiece at a minimum height of about six millimeters (or about one-quarter of an inch) when the workpiece defines a thickness of about one-half of an inch. Stated differently, the joiner jig 1 enables a drill bit of the joiner tool 2 to cut a mortise in the center of a workpiece when the drill bit of the joiner tool 2 is at the minimum height of about six millimeters (or about one-quarter of an inch) away from the base table 10 when the workpiece defines a thickness of about one-half of an inch. In the illustrated embodiment, the joiner jig 1 also enables the joiner tool 2 to cut a mortise in the center of a workpiece at a maximum height of about thirty millimeters (or about 1 3/16 inch) when the workpiece defines a thickness of about 2⅜ inches. Stated differently, the joiner jig 1 also enables a drill bit of the joiner tool 2 to cut a mortise in the center of a workpiece when the drill bit of the joiner tool 2 is at the maximum height of about thirty millimeters (or about 1 3/16 inch) when the workpiece defines a thickness of about 2⅜ inches

Having now described the structure and assemblies of the joiner jig 1, methods of using the joiner jig 1 is described in more detail below.

Prior to introducing a first workpiece “WP1” to the joiner jig 1, a woodworker may select a suitable angle to position the moveable portion 18 relative to the fixed portion 16 based on the woodworking project. As illustrated in FIG. 10A, the woodworker maintains the moveable portion 18 at a first position relative to the fixed portion 16 where the third side 16C of the fixed portion 16 and the third side 18C of the moveable portion 18 are directly abutting one another. As illustrated in FIG. 10A, the moveable portion 18 is also positioned at a first angle “A” relative to the first side 16A of the fixed portion 16 where the first angle “A” is forty-five degrees. Once the moveable portion 18 is set at the first angle “A”, the woodworker may introduce a first workpiece “WP” to the joiner jig 1. Here, a first outermost end “OE1” of the first workpiece “WP” operably engages with the second side 18D of the moveable portion 18 and an angled second outermost end “OE2” may be operably engaged with the front plate 2C of the joiner tool 2. Once engaged, the first workpiece “WP1” is angled at the first angle “A” defined by the moveable portion 18 relative to the fixed portion 16. At this point, the woodworker may then drill a mortise into the angled second outermost end “OE2” of the first workpiece.

Prior to introducing a workpiece to the joiner jig 1, the woodworker may also select a suitable distance to position the adjustable protractor assembly 14 away from the drill bit of the joiner tool 2 based on the woodworking project. As illustrated in FIG. 10A, the woodworker loosens the connectors 30 from the spacing gauge 28 to enable the woodworker to longitudinally move the spacing gauge 28 along the first end 16A of the fixed portion 16. Such longitudinally movement of the spacing gauge 28 along the first end 16A of the fixed portion 16 is denoted by an arrows labeled “LM” in FIG. 10A. The woodworker may continue to longitudinally move the spacing gauge 28 until a desired distance is selected by the woodworker to space the adjustable protractor assembly 14 away from the joiner tool 2. As illustrated in FIG. 10A, the woodworker operably engages the stopper 28E of the spacing gauge 28 with one of the drill stops 2E1, 2E2 to maintain the desired distance between the adjustable protractor assembly 14 and the joiner tool 2 without remeasuring and resetting the desired distance. Once the desired distance has been selected, the woodworker tightens the connectors 30 to the spacing gauge 28 to prevent longitudinally movement of the spacing gauge 28 along the first end 16A of the fixed portion 16.

The woodworker may also move the adjustable protractor assembly 14 from a first orientation (as shown in FIG. 10A) to mirrored, second orientation (see FIG. 10B) on the base table 10. The woodworker may desire to change the orientation of the adjustable protractor assembly 14 from the first orientation (see FIG. 10A) to the second orientation (see FIG. 10B) when the woodworker is drilling a matching mortise into a second workpiece “WP2” that may be used in conjunction with the mortise bored into the first workpiece “WP1”. In other words, this transitions between the first orientation and the second orientation of the adjustable protractor assembly 14 enables a woodworker to maintain the desired drilling angle when drilling mortises into different types of workpiece so that at least one mortise of one workpiece is axially aligned with at least another mortise of another workpiece.

As illustrated in FIG. 10B, the woodworker removes the locking knob 32 from the fixed portion 16 and positions the adjustable protractor assembly 14 from the first set of adjustment threaded openings 10J1 to the second set of adjustment threaded openings 10J2. Once the adjustment slot 16J is aligned with the second set of adjustment threaded openings 10J2, the woodworker threadably engages the locking knob 32 with an adjustment threaded opening of the second set of adjustment threaded openings 10J2 to secure the fixed portion 16 with the base table 10. As illustrated herein, the second workpiece “WP2” is also provided at a congruent angle “A” defined by the moveable portion 18 relative to first end 16A of the fixed portion 16; the congruent angle “A” is congruent to the first angle “A” of the moveable portion 18 relative to first end 16A of the fixed portion 16 in the first orientation. Moreover, the spacing gauge 28 is also provided at the same distance as selected in the first orientation so that the woodworker may quickly arrange the adjustable protractor assembly 14 at the same distance away from the joiner tool 2 to drill a matching mortise into the second workpiece “WP2”.

The woodworker may also adjust the movable portion 18 to any angle defined by the range of angles of the adjustment plate 20. Prior to rotation of the moveable portion 18, the woodworker applies a counterclockwise rotational movement on the adjustment dial 24 to loosen the adjustment dial 24 from the adjustment plate 20. Such loosening allows the woodworker to allow rotation of the moveable portion 18 relative to the fixed portion 16. Such rotational movement by the woodworker on the adjustment dial 24 is denoted by an arrow labeled “RM1” in FIG. 11A.

Once the adjustment dial 24 is loosened, the woodworker then rotates the moveable portion 18 away from the fixed portion 16 to a second position relative to the fixed portion 16 where the third side 16C of the fixed portion 16 and the third side 18C of the moveable portion 18 are free from engaging one another. Such rotation of the moveable portion 18 away from the fixed portion is denoted by an arrow labeled “RM2” in FIG. 11A. As illustrated in FIG. 11A, the moveable portion 18 is provided at a second angle “B” relative to the fixed portion 16 where the second angle “B” is greater than the first angle “A” as shown in FIG. 10A. In the illustrated embodiment, the second side 18D of the moveable portion 18 is provided at about a ninety degree angle relative to the first side 16A of the fixed portion 16. Once the moveable portion 18 is set at the second angle “B”, the woodworker applies a clockwise rotational movement on the adjustment dial 24 to secure the adjustment dial 24 against the adjustment plate 20. Such securing of the adjustment dial 24 against the adjustment plate 20 maintains the moveable portion 18 at the second angle “B” relative to the fixed portion 16. Such rotational movement by the woodworker on the adjustment dial 24 is denoted by an arrow labeled “RM3” in FIG. 11B.

Prior to introducing a workpiece to the joiner jig 1, a woodworker operably engages the joiner tool 2 with the tool mounting assembly 40. Specifically, the base 2B of the joiner tool 2 operably engages with the mount plate 62 via connectors (not illustrated). Once the joiner jig 1 is operably engaged with the tool mounting assembly 40, the woodworker may adjust the height of the joiner tool 2 relative to a workpiece by raising or lowering the mount plate 62 of the tool mounting assembly 40 via the adjustment mechanism between the bolts 52 and the micro-adjusting knobs 54.

As illustrated in FIG. 11A, the woodworker rotates the micro-adjusting knobs 54 about the bolts 52 in order to raise or lower the mount plate 62, which, in turn, raises or lowers the joiner tool 2 relative to a workpiece. Such rotational movement of the micro-adjusting knobs 54 about the bolts 52 is denoted by double arrows labeled “RM4” in FIG. 11A. To lower the joiner tool 2, the woodworker applies a first rotational force on each micro-adjusting knob 54 in a first clockwise direction to screw the respective bolt 52 into the micro-adjusting knob 54. Such rotational force causes each micro-adjusting knob 54 to move longitudinally downwardly along the respective bolt 52 towards the base plate 42. With this screw mechanism between each bolt 52 and each micro-adjusting knob 54, each micro-adjusting knob 54 also forces the respective tube post 48 to move longitudinally downwardly along the respective bolt 52 towards the base plate 42. During this lowering process, each biaser 56 exerts an expansion force on the respective riser 46 and respective tube post 48 to maintain position that changed from the initial position to the lowered position.

Once the joiner tool 2 has been lowered to a desired height relative to a workpiece, the woodworker may then cease the rotational force on each micro-adjusting knob 54 in the first clockwise direction. At the desired height, the woodworker may then apply a rotational force on each locking knob 60 in a clockwise direction to screw each locking knob 60 into the respective side threaded passageway 48G. The woodworker may cease the rotational force on each locking knob 60 once the locking knob 60 tightens against the circumferential wall 46C of each riser 46; such engagement between each locking knob 60 and each riser 46 further maintains and/or locks the lowered position.

The woodworker may also raise the joiner tool 2 via the tool mounting assembly 40 similar to method of lowering the joiner tool 2 via the tool mounting assembly 40. To raise the joiner tool 2, the woodworker may apply a second rotational force on each micro-adjusting knob 54 in a counterclockwise direction to screw the respective bolt 52 into the micro-adjusting knob 54. Such rotational force causes each micro-adjusting knob 54 to move longitudinally upwardly along the respective bolt 52 away from the base plate 42. With this screw mechanism between each bolt 52 and each micro-adjusting knob 54, each micro-adjusting knob 54 also forces the respective tube post 48 to move longitudinally upwardly along the respective bolt 52 away from the base plate 42. During this raising process, each biaser 56 still exerts an expansion force on the respective riser 46 and respective tube post 48 to help assist the upward longitudinal movement from the initial position to the raised position.

Once the joiner tool 2 has been raised to a desired height relative to a workpiece, the woodworker may then cease the rotational force on each micro-adjusting knob 54 in the counterclockwise direction. At the desired height, the woodworker may then apply a rotational force on each locking knob 60 in a clockwise direction to screw each locking knob 60 into the respective side threaded passageway 48G (similar to the lowering process described above). The woodworker may cease the rotational force on each locking knob 60 once the locking knob 60 tightens against the circumferential wall 46C of each riser 46; such engagement between each locking knob 60 and each riser 46 further maintains and/or locks the lowered position.

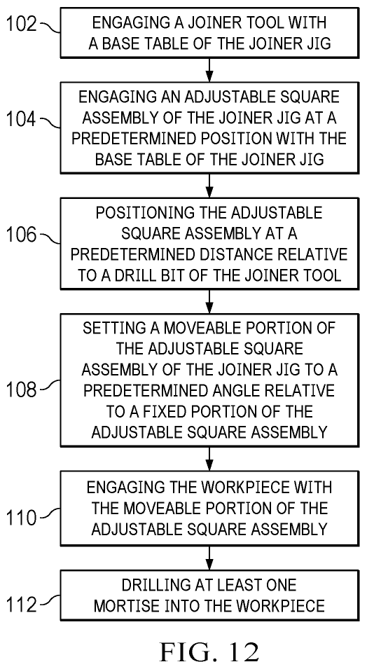

FIG. 12 illustrates a method 100 of drilling at least one mortise into a workpiece with a joiner jig. An initial step 102 of method 100 comprises engaging a joiner tool with a base table of the joiner jig. Another step 104 comprises engaging an adjustable protractor assembly of the joiner jig at a predetermined position with the base table of the joiner jig. Another step 106 comprises positioning the adjustable protractor assembly at a predetermined distance relative to a drill bit of the joiner tool. Another step 108 comprises pivoting a moveable portion of the adjustable protractor assembly of the joiner jig to a predetermined angle relative to a fixed portion of the adjustable protractor assembly. Another step 110 comprises engaging the workpiece with the moveable portion of the adjustable protractor assembly. Another step 112 comprises drilling at least one mortise into the workpiece.

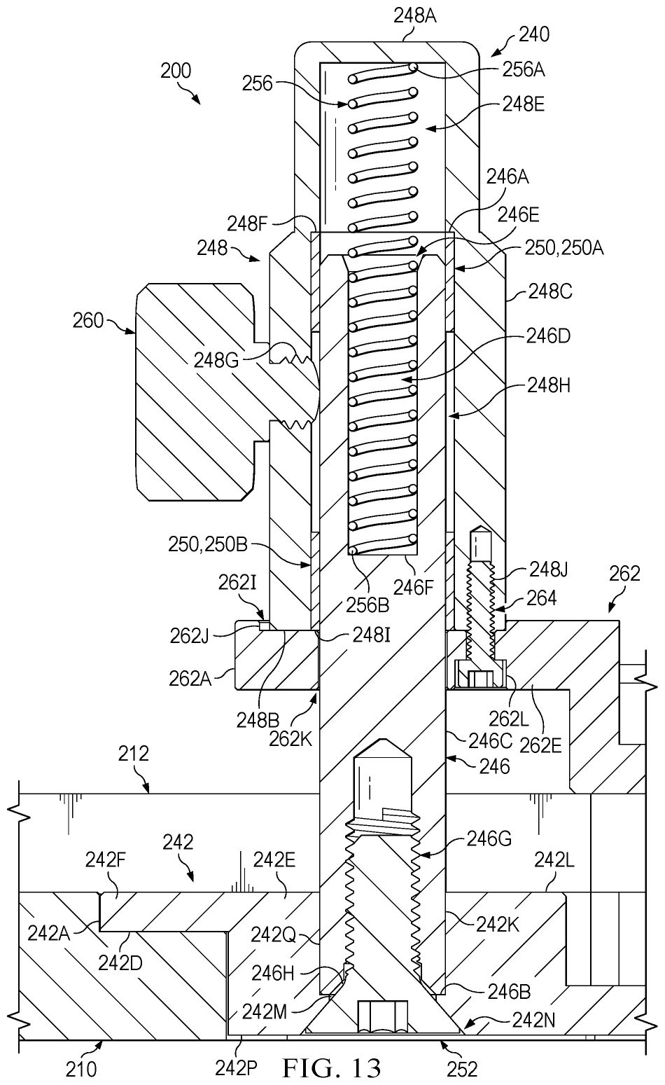

FIG. 13 illustrates another joiner jig 200 that enables a woodworker to operatively engage the joiner tool 2 to enable the joiner tool 2 to cut and/or bore mortises and similar holes into a workpiece at a range of angles. The joiner jig 200 includes a base table 210, at least one fence 212, an adjustable protractor assembly (not illustrated herein) and a tool mounting assembly 240 that is substantially similar to the joiner jig 1 as described above and illustrated in FIGS. 1-11; except as detailed below.

The tool mounting assembly 240 includes a base plate 242. The base plate 242 operably engages with the base table 210 identical to the base table 10 and the base plate 42 described above. As illustrated in FIG. 13, the base plate 242 includes a first end 242A, a second end (not illustrated) opposite to the first end, and a longitudinal axis defined therebetween. The base plate 242 also includes a first side (not illustrated), a second side 242D opposite to the first side, and a transverse axis defined therebetween. Still referring to FIG. 13, the base plate 242 includes a first foot 242E that extends from the first end 242A towards the second end. The base plate 242 also includes a first lip 242F extends longitudinally away from the first end 242A and away from the first foot 242E towards a first end of the base table 210. The base plate 242 also includes a platform 242G that extends from the first foot 242E to a second foot (not illustrated) of the base plate 242. The second foot extends from the second end to the platform 242G.

Referring to FIG. 13, the base plate 242 also defines at least one riser cavity 242K. The at least one riser cavity 242K extends into the base plate 242 in one of the first foot 242E and the second foot. Specifically, the at least one riser cavity 242K extends from a top surface 242L of one of the first foot 242E and the second foot to an interior shoulder 242M. In the illustrated embodiment, the base plate 42 defines a riser cavity 242K in the first foot 242E and another riser cavity 242K in the second foot.

Still referring to FIG. 13, the base plate 242 also defines at least one riser through-hole 242N where the at least one riser through-hole 242N extends into the base plate 242 in one of the first foot 242E and the second foot 242H. Specifically, the at least one riser through-hole 242N extends from the interior shoulder 242M to a bottom surface 242P of one of the first foot 242E and the second foot 242H. In the illustrated embodiment, the base plate 242 defines a riser through-hole 242N in the first foot 242E and another riser through-hole 242N in the second foot.

Still referring to FIG. 13, the base plate 42 also includes a planar interior wall 242Q inside each foot 242E. Each planar interior wall 242Q that extends downwardly from the top surface 242L of each foot 242E to the interior shoulder 242M of each foot 242E. The planar interior wall 242Q is positioned orthogonal to the inner shoulder 242M of each foot 242E. Such use and purpose of the planar interior wall 242Q inside each foot 242E is described in more detail below.

The tool mounting assembly 40 also includes at least one riser 246. As illustrated in FIG. 13, the at least one riser 246 operably engages with the base plate 242 inside of the at least one riser cavity 242K. In the illustrated embodiment, the tool mounting assembly 240 includes two risers 246 that operably engages with the first foot 242E of the base plate 242 and with the second foot of the base plate 242. The two risers 246 are substantially similar to one another and operably engaged with the base plate 242 in the same orientation. Inasmuch as the risers 246 are substantially similar to one another, the following description will relate to the riser 246 operably engaged with the first foot 242E of the base plate 242. It should be understood, however, that the description of the riser 246 operably engaged with the first foot 242E applies substantially equal to the riser 246 operably engaged with the second foot 242H of the base plate 242.

Referring to FIG. 13, the riser 246 includes a first or upper end 246A, a second or lower end 246B that is opposite to the upper end 246A, a circumferential wall 246C extending between the upper and lower ends 246A, 246B, and a longitudinal axis defined therebetween. The riser 46 defines an upper passageway 246D that extends from an upper opening 246E defined at the upper end 246A to a base wall 246F positioned between the upper end 246A and the lower end 246B. The riser 246 also defines a lower threaded passageway 246G that extends from a lower opening 246H defined at the lower end 246B of the riser 246 towards the base wall 246F; the upper passageway 246D and the lower threaded passageway 246G are separate and isolated from one another. The riser 46 also defines an indentation 2461 that extends radially into the riser 246 proximate to the lower end 246B of the riser 246. The indentation 2461 provides a locking mechanism between the riser 246 and the base plate 242 to prevent rotation or movement of the riser 246 about the longitudinal axis of the riser 246 during operation. Specifically, the indentation 2461 enables a portion of the circumferential wall 246C to operably engage with the planar interior wall 242Q of a foot of the base plate 242 to prevent rotation or movement of the riser 246 about the longitudinal axis of the riser 246 during operation.

The tool mounting assembly 240 also includes at least one tube post 248. As illustrated in FIG. 13, the at least one tube post 248 is operably engaged with the at least one riser 246 and is disposed about the at least one riser 246. In the illustrated embodiment, the tool mounting assembly 240 includes two tube posts 248 that operably engages with the two risers 246 described above. The two tube posts 248 are substantially similar to one another and are operably engaged with the two risers 246 in the same orientation. Inasmuch as the tube posts 248 are substantially similar to one another, the following description will relate to the tube post 248 operably engaged with the riser 246 that is operably engaged with the first foot 242E. It should be understood, however, that the description of the tube post 48 operably engaged with the first riser 246 inside of the first foot 242E applies substantially equal to the tube post 248 operably engaged with the second riser 246 that is operably engaged with the second foot.

Referring to FIG. 13, the tube post 248 includes a first or upper end 248A, a second or lower end 248B opposite to the upper end 248A, a circumferential wall 248C extending between the upper and lower ends 248A, 248B, and a longitudinal axis defined therebetween that is parallel with the longitudinal axis of the riser 246. The tube post 248 defines an upper aperture 248D at the upper end 248A of the tube post 248. The tube post 248 also defines an upper passage 248E that extends from the upper aperture 248D to an interior shoulder 248F. The tube post 248 also defines a side threaded passageway 248G that extends into the circumferential wall 248C along an axis orthogonal to the longitudinal axis of the tube post 248; such use and purpose of the side threaded passageway 248G is described in more detail below.

Still referring to FIG. 13, the tube post 248 defines a lower passage 248H that extends from the interior shoulder 248F to a lower aperture 2481 defined at the lower end 248B of the tube post 248. The tube post 248 also defines at least one vertical threaded passageway 248J that extends into the tube post 248 from the lower end 248B towards the upper end 248A. The at least one vertical threaded passageway 248J is separate from the upper passage 248E and the lower passage 248H. Such use and purpose of the at least one vertical threaded passageway 248J is described in more detail below.

The tool mounting assembly 240 also includes at least one bunting bearing 250 that operably engages with each riser 246 and each tube post 248. As illustrated in FIG. 13, an upper bunting bearing 250A operably engages about a portion of the riser 246 and operably engages with the tube post 248 inside of the lower passage 248H. Specifically, the upper bunting bearing 250A operably engages with the interior shoulder 248F of the tube post 248 inside of the lower passage 248H. Still referring to FIG. 13, a lower bunting bearing 250B operably engages about another portion of the riser 246 and operably engages with the tube post 248 inside of the lower passage 248H. Specifically, the lower bunting bearing 250B operably engages with a mount plate 262 (described below) inside of the lower passage 248H. The bunting bearings 250A, 250B are configured to reduce friction between the riser 246 and the tube post 248 to allow the tube post 248 to move longitudinally along the riser 246 for raising or lowering the joiner tool 2 during a woodworking project.

The tool mounting assembly 240 also includes bolt 252 that operably engages with each riser 46. Referring to FIG. 13, the bolt 252 is configured to threadably engage with the lower threaded passageway 246G of the riser 246 to secure the riser 246 with the base plate 242. Once the riser 246 is secured, the bolt 252 is housed inside of the riser 246.

The tool mounting assembly 240 also includes a biaser 256. Referring to FIG. 13, the biaser 256 includes an upper end 256A, a lower end 256B opposite to the upper end 256A, and a longitudinal axis defined therebetween. As illustrated in FIG. 13, a portion of the biaser 256 from the upper end 256A towards the lower end 256B is positioned inside of the upper passageway 246D of the riser 246. Additionally, another portion of the biaser 256 from the lower end 256B towards the upper end 526A is positioned inside of the upper passage 248E of the tube post 248. Additionally, the upper end 526A of the biaser 256 operably engages with the circumferential wall 248C of the tube post 248 at the upper end 248A. The lower end 256B of the biaser 256 also operably engages with the base wall 246F of the riser 246. The biaser 256 is also positioned circumferentially about the bolt 252. The use and function of the biaser 256 is identical to the use and function of the biaser 56 as described above.

The tool mounting assembly 240 also includes a locking knob 260. Referring to FIG. 9, the locking knob 260 threadably engages with the tube post 248 via the side threaded passageway 248G. During operation, the locking knob 260 operably engage with the riser 246 to hold and lock the riser 246 at a desired position relative to the tube post 248. Such use and function of the locking knob 260 is identical to the use and function of the locking knob 60 as described above.

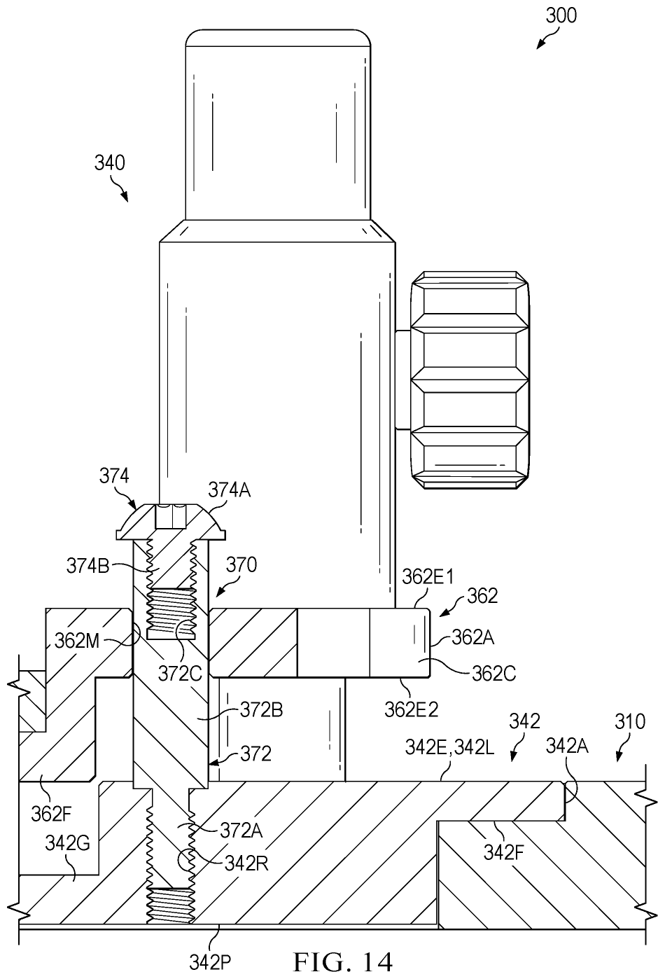

The tool mounting assembly 240 also includes a mount plate 262. Referring to FIG. 14, the mount plate 262 includes a first end 262A, a second end (not illustrated) opposite to the first end 262A, and a longitudinal axis defined therebetween. The mount plate 262 also includes a first side (not illustrated), a second side (not illustrated) opposite to the first side, and a transverse axis defined therebetween. The mount plate 262 also includes a first arm 262E that extends from the first end 262A towards a platform 262F. The mount plate 262 also includes a second arm (not illustrated) that extends from the second end towards the platform 262F where the second arm is opposite to the first arm 262E. The platform 262F of the mount plate 262 is positioned vertically below the first arm 262E and the second arm. As illustrated in FIG. 13, the structural configuration of the mount plate 262 is complementary to the structural configuration of the base plate 242 so that the mount plate 262 may be housed inside of the base plate 242 for cutting thinner types of workpiece for certain woodworking projects, which is described in more detail below.

Referring to FIG. 13, the mount plate 262 defines attachment threaded holes 262H. Specifically, the attachment threaded holes 262H are defined in the platform 262F to allow connectors (not illustrated) to pass through the attachment threaded holes 262H so such connectors operably engage the joiner tool 2 with the mount plate 62. In other exemplary embodiments, any suitable connection mechanism may be used to operably engage a joiner tool with a mount plate of a tool mounting assembly.

The mount plate 262 also defines a tube post cavity 262I in each of the first arm 262E and the second arm. As illustrated in FIG. 13, the tube post cavity 262I defined in the first arm 262E extends downwardly into the first arm 262E to an inner shoulder 262J. Still referring to FIG. 13, a portion of the respective tube post 248 and a portion of the respective bunting bearings 250A, 250B are received by the tube post cavity 262I in the first arm 262E. Additionally, the lower end 248B of the tube post 248 and lower bunting bearing 250B operably engage with the inner shoulder 262J inside of the tube post cavity 262I of the first arm 262E. Such configuration of the tube post cavity 262I and the inner shoulder 262J of the second arm is substantially similar to the tube post cavity 262I and the inner shoulder 262J of the first arm 262E.

The mount plate 262 also defines a tube post through-hole 262K in each of the first arm 262E and the second arm 262G. As illustrated in FIG. 13, the tube post through-hole 262K defined in the first arm 262E extends downwardly from the inner shoulder 262J where the riser 246 and the mount plate 262 operably engaged with one another inside of the tube post through-hole 262K. Such configuration of the tube post through-hole 262J of the second arm is substantially similar to the tube post through-hole 262J of the first arm 262E.

The mount plate 262 also defines at least one lower through-hole 262L in each of the first arm 262E and the second arm 262G. As illustrated in FIG. 13, the at least one lower through-hole 262L defined in the first arm 262E extends vertically through the first arm 262E. The at least one lower through-hole 262L defined in the first arm 262E is coaxial with the at least one vertical threaded passageway 248J of the tube post 248. Such alignment of the at least one lower through-hole 262L and the at least one vertical threaded passageway 248J allows a fastener 264 to be received by the mount plate 262 and to threadably engage with the at least one vertical threaded passageway 248J. Such engagement by the fastener 264 operably engages the tube post 248 and the first arm 262E of the mount plate 262 with one another. Such configuration of the at least one lower through-hole 262L defined in the second arm is substantially similar in operably engaging the tube post 248 and the second arm 262G of the mount plate 262 with one another via a fastener 264.

During operation, the woodworker using the joiner jig 200 may vertically move the joiner tool 2 vertically upward and/or downward to adjust the height of the joiner tool 2 relative to the workpiece. Such vertical adjustment may be used in order to adjust the height of the joiner tool 2 based on the thickness of the workpiece. In this embodiment, a woodworker would apply downwardly vertical movement on one or more of the joiner tool 2, the tube post 248, the locking knob 250, and the mount plate 62 to adjust the height of the joiner tool 2 relative to the workpiece until a desired height is met. Once at the desired position, the woodworker would tighten the locking knobs 250 against the risers 246 until the risers 246 would remain at the desired height. If a new desired height is required, the woodworker loosens the locking knobs 250 from the risers 246 until the risers 246 are free to move inside of the tube posts 248.

FIG. 14 illustrates another joiner jig 300 that enables a woodworker to operatively engage the joiner tool 2 to enable the joiner tool 2 to cut and/or bore mortises and similar holes into a workpiece at a range of angles. The joiner jig 300 includes a base table 310, at least one fence (not illustrated), an adjustable protractor assembly (not illustrated), a tool mounting assembly 340 that is substantially similar to the joiner jig 1 as described above and illustrated in FIGS. 1-11; except as detailed below. The joiner jig 300 includes a height limiting assembly 370 that operably engages with the tool mounting assembly 340, which is described in more detail below.

The tool mounting assembly 340 includes a base plate 342. The base plate 342 operably engages with the base table 310 identical to the base table 10 and the base plate 42 described above. As illustrated in FIG. 14, the base plate 342 includes a first end 342A, a second end (not illustrated) opposite to the first end, and a longitudinal axis defined therebetween. The base plate 342 also includes a first side (not illustrated), a second side (not illustrated) opposite to the first side, and a transverse axis defined therebetween. Still referring to FIG. 14, the base plate 342 includes a first foot 342E that extends from the first end 342A towards the second end. The base plate 342 also includes a first lip 342F extends longitudinally away from the first end 342A and away from the first foot 342E towards a first end of the base table 310. The base plate 342 also includes a platform 342G that extends from the first foot 342E to a second foot (not illustrated) of the base plate 342. The second foot extends from the second end to the platform 342G.

Still referring to FIG. 14, the base plate 342 also defines a threaded passageway 342R that extends entirely through the first foot 342E from a top surface 342L of the first foot 342E to a bottom surface 342P of the first foot 342E; the top surface 342L and the bottom surface 342P are in fluid communication with one another via the threaded passageway 342R. Such use and purpose of the threaded passageway 342R is described in more detail below.

The tool mounting assembly 340 also includes a mount plate 362 substantially similar to the mount plates 62, 262, except as detail below. Referring to FIG. 14, the mount plate 362 includes a first end 362A, a second end (not illustrated) opposite to the first end 362A, and a longitudinal axis defined therebetween. The mount plate 362 also includes a first side (not illustrated), a second side 362D opposite to the first side, and a transverse axis defined therebetween. The mount plate 362 also includes a first arm 362E that extends from the first end 362A towards a platform 362F. The mount plate 362 also includes a second arm (not illustrated) that extends from the second end towards the platform 362F where the second arm is opposite to the first arm 362E. The platform 362F of the mount plate 362 is positioned vertically below the first arm 362E and the second arm. As illustrated in FIG. 14, the structural configuration of the mount plate 362 is complementary to the structural configuration of the base plate 342 so that the mount plate 362 may be housed inside of the base plate 342 for cutting thinner types of workpiece for certain woodworking projects, which is described in more detail below.

Still referring to FIG. 14, the mount plate 362 also defines a hole 362M that extends entirely through the first arm 362E between an upper surface 362E1 of the first arm 362E through a lower surface 362E2 of the first arm 362E; the upper surface 362E1 of the first arm 362E and the lower surface 362E2 of the first arm 362E are in fluid communication with one another via the hole 362M. Such use and purpose of the hole 362M is described in more detail below.

Still referring to FIG. 14, the joiner jig 300 may include a height limiting assembly 370 that operably engages with the base plate 342 and the mount plate 362 for limiting and/or restricting upward vertical movement of the mount plate 362 relative to the base plate 342; such restriction of upward vertical movement of the mount plate 362 is described in more detail below.

The height limiting assembly 370 includes a standoff 372 that operably engages with base plate 342 via the threaded passageway 342R. Specifically, the standoff 372 includes a threaded shaft 372A that threadably engages with the base plate 342 to maintain the standoff 372 with the base plate 342. The standoff 372 also includes a blanked portion 372B that defines a threaded chamber 372C extending downwardly into the blanked portion 372B towards the threaded shaft 372A. Such use and purpose of the threaded chamber 372C defined in the standoff 372 is described in more detail below.

The height limiting assembly 370 also includes a button screw 374 that operably engages with the standoff 372. Specifically, the button screw 374 threadably engages with the standoff 372 via the threaded chamber 372C. The button screw 374 includes a head 374A and a threaded shaft 374B that extends downwardly away from the head 374A as illustrated in FIG. 14. Upon assembly, the threaded shaft 374B is threadably engaged with the threaded chamber 372C of the standoff 372, and the head 374A is positioned outside of the threaded chamber 372C.

During operation, the mount plate 362 slideably engages with the standoff 372, particularly with the blanked portion 372B, to enable the mount plate 362 to vertically move along the standoff 372 without being impeded. The screw 374, however, restricts the upward vertical movement of the mount plate 362 to cut larger sizes of workpiece. Specifically, the head 374A of the screw 374 directly abuts the upper surface 362E1 of the first arm 362E to restricts the upward vertical movement of the mount plate 362. When the head 374A directly abuts the first arm 362E, the mount plate 362 is provided at the maximum height for enabling the joiner tool 2 to cut mortises into thicker types of workpiece. In this illustrated embodiment, the joiner tool 2 is configured to cut a mortise at about 30 millimeters or about 1 3/16 inches to center of the workpiece when the workpiece defines a thickness of about 2⅜ inches.

In other exemplary embodiments, the height limiting assembly 370 of the joiner jig 300 may be used in any other suitable embodiments described and illustrated herein, include joiner jig 1 and joiner jig 200, for limiting upwardly vertical movement and height of any mount plate provided in any joiner jig described and illustrated herein.

During operation, any mount plate described and illustrated herein, including mount plate 62, 262, 362, is fully removable from any riser that the mount plate is operably engaged with, including risers 46, 246. Such removal of the mount plate from the riser is suitable when the woodworker must be use the joiner tool 2 for hand-held work and when a workpiece is not suitable and/or configured to rest on a respective base table of a joiner jig described and illustrated herein due to the size, shape, and/or dimensions of the workpiece. In this instance, the mount plate and the joiner jig remain with one another while the woodworker drills and/or cuts at least one mortise into the workpiece.

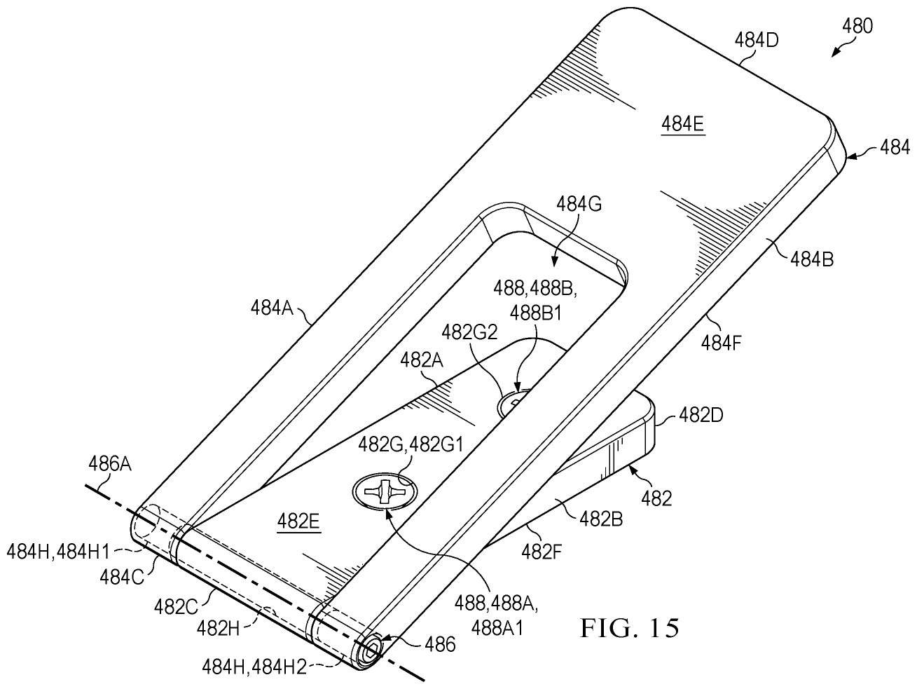

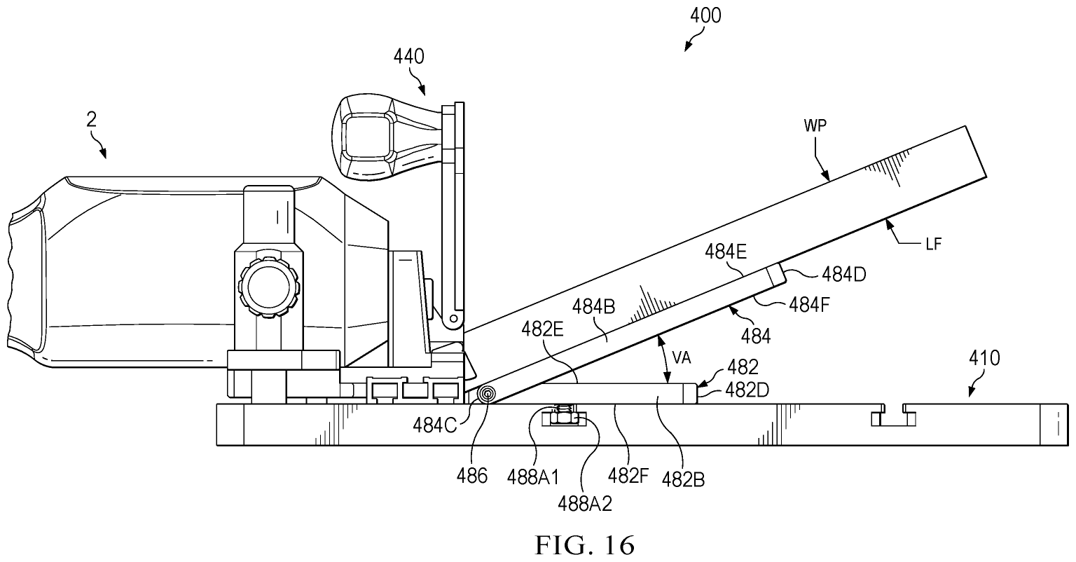

FIGS. 15 and 16 illustrates a joiner jig 400 that includes a base plate 410, at least one fence (not illustrated), an adjustable protractor assembly (not illustrated), a tool mounting assembly 440, and a height limiting assembly (not illustrated); the components and assembly of the joiner jig 400 are substantially similar to the joiner jigs 1, 200, 300 described and illustrated above, expect as detailed below. The joiner jig 400 also includes an accessory 480 that is configured to operably engaged with the joiner jig 400, particularly the base table 410 of the joiner jig 400, and is configured to hold and maintain a workpiece at a vertical angle relative to the joiner tool 2. In other exemplary embodiments, the accessory 480 may be operably engaged with any suitable joiner jig described and illustrated herein, including joiner jigs 1, 200, 300. The parts and components of the accessory 480 are described in more detail below.

Referring to FIG. 15, the accessory 480 includes a base member 482 that operably engages with the base table 410 of the joiner jig 400. The base member 482 includes a first side 482A, a second side 482B transversely opposite to the first end 482A, and a transverse axis defined therebetween. The base member 482 also includes a first end 482C positioned between the first side 482A and the second side 482B, a second end 482D positioned between the first side 482A and the second side 482B and longitudinally opposite to the first end 482C, and a longitudinal axis defined therebetween. The base member 482 also includes a top surface 482E positioned vertically above the first side 482A, the second side 482B, the first end 482C, and the second end 482D, a bottom surface 482F positioned vertically below the first side 482A, the second side 482B, the first end 482C, and the second end 482D and opposite to the top surface 482E, and a vertical axis defined therebetween. Upon engagement of the accessory 480 with the base table 410, the bottom surface 482F rests on a top surface of base table 410 (See FIG. 16).

Still referring to FIG. 15, the base member 482 also includes at least one through-hole 482G positioned intermediate the first end 482C and the second end 482D and extends entirely through the base member 482 between the top surface 482E and the bottom surface 482F. In the illustrated embodiment, the base member 482 defines a first through-hole 482G1 positioned intermediate the first end 482C and the second end 482D proximate to the first end 482C. The first through-hole 482G1 also extends entirely through the base member 482 from the top surface 482E and the bottom surface 482F in which the top surface 482E and the bottom surface 482F are in fluid communication with one another via the first through-hole 482G1. Similarly, the base member 482 also defines a second through-hole 482G2 positioned intermediate the first through-hole 482G1 and the second end 482D proximate to the second end 482D. The second through-hole 482G2 also extends entirely through the base member 482 from the top surface 482E and the bottom surface 482F in which the top surface 482E and the bottom surface 482F are in fluid communication with one another via the second through-hole 482G2. Such use and purpose of the first through-hole 482G1 and the second through-hole 482G2 are described in more detail below.

Still referring to FIG. 15, the base member 482 further defines threaded passageway 482H that transversely extends from the first side 482A to the second side 482B. In the illustrated embodiment, the threaded passageway 482H provides fluid communication between the first side 482A and the second side 482B due to the threaded passageway 482H extending entirely through the base member 482. The threaded passageway 482H is also separate and spaced apart from the first through-hole 482G1 and the second through-hole 482G2. Such use and purpose of the threaded passageway 482H is described in more detail below.

Still referring to FIG. 15, the accessory 480 also includes a pivot member 484 that operably engages with the base member 482. More particularly, the pivot member 484 of the accessory 480 is pivotally moveable with the base member 482 from a range of angles, which is described in more detail below. As described in more detail below, the pivot member 484 is also configured to hold and maintain a workpiece at a desired vertical angle relative to the base member 482 and/or the joiner tool 2 to enable the joiner tool 2 to drill a mortise into the workpiece at the desired vertical angle. The features and characteristics of the pivot member 484 is described in more detail below.

Still referring to FIG. 15, the pivot member 484 includes a first side 484A, a second side 484B transversely opposite to the first end 484A, and a transverse axis defined therebetween. The pivot member 484 also includes a first end 484C positioned between the first side 484A and the second side 484B, a second end 484D positioned between the first side 484A and the second side 484B and longitudinally opposite to the first end 484C, and a longitudinal axis defined therebetween. The pivot member 484 also includes a top surface 484E positioned vertically above the first side 484A, the second side 484B, the first end 484C, and the second end 484D, a bottom surface 484F positioned vertically below the first side 484A, the second side 484B, the first end 484C, and the second end 484D and opposite to the top surface 484E, and a vertical axis defined therebetween. Upon engagement of the accessory 480 with a workpiece, the top surface 482E engages with a longitudinal face of the workpiece for maintaining the workpiece at a desired vertical angle relative to the base member 482 (see FIG. 16).

Still referring to FIG. 15, the pivot member 484 further defines a U-shaped notch 484G that extends longitudinally from the first end 484C towards the second end 484D. As illustrated in FIG. 15, the notch 484G also extends entirely through the pivot member 484 between the top surface 484E and the bottom surface 484F in which the top surface 484E and the bottom surface 484F are in fluid communication with one another. The notch 484G defined by the pivot member 484 is configured to receive the entire base member 482 when the pivot member 484 is provided in a collapsed position. In this collapsed position, the top surface 482E of the base member 482 and the top surface 484E of the pivot member 484 are coplanar with one another. A woodworker may place collapse the pivot member 484 around the base member 482 when the accessory 480 is not needed and/or not used for a woodworking project.

Still referring to FIG. 15, the pivot member 484 further defines at least one threaded passage 484H that transversely extends from one of the first side 484A and the second side 484B to the notch 484G. In the illustrated embodiment, the pivot member 484 defines a first threaded passage 484H1 that transversely extends from the first side 484A to the notch 484G; the first threaded passage 484H1 provides fluid communication between the first side 484A and the notch 484G. Similarly, the pivot member 484 defines a second threaded passage 484H2 that transversely extends from the second side 484B to the notch 484G; the second passageway also 484H2 provides fluid communication between the second side 484B and the notch 484G. In the illustrated embodiment, the first threaded passage 484H1 and the second threaded passage 484H2 are coaxial with one another and directly oppose one another. Such use and purpose of the first threaded passage 484H1 and the second threaded passage 484H2 are described in more detail below.

Still referring to FIG. 15, the accessory 480 includes at least one pivot shaft 486 pivotally engaging the base member 482 and the pivot member 484 with one another. More particularly, the at least one pivot shaft 486 pivotally engages the base member 482 and the pivot member 484 with one another via the threaded passageway 482H defined by the base member 482 and one of the first threaded passage 484H1 and the second threaded passage 484H2 defined by the pivot member 484. In the illustrated embodiment, the at least one pivot shaft 486 pivotally engages the second end 484D of the pivot member 484 with the second end 482D of the base member 482. In the illustrated embodiment, the at least one pivot shaft 486 is a connector and/or fastener that is threadably engaged with the second side 482D of the base member 482, via the threaded passageway 482H, and the second side 484D of the pivot member 484, via the second threaded passage 484H2, to enable the pivot member 484 to pivot about a longitudinal axis 486A of the pivot shaft 486.

During a woodworking project, a woodworker may freely pivot the pivot member 484 to a desired vertical angle relative to the base member 482 when the pivot shaft 486 is disengaged from the pivot member 484. In this same woodworking project, the woodworker may also retain the pivot member 484 at the desired vertical angle relative to the base member 482 when the pivot shaft 486 is engaged with the pivot member 484. As such, the pivot shaft 486 creates a compression mechanism between the base member 482 and the pivot member 484 to retain the pivot member 484 at the desired vertical angle relative to the base member 482 when the pivot shaft 486 is tightened to and engaged with both the base member 482 and the pivot member 484.

In other exemplary embodiments, additional pivot shafts 486 may be operably engaged with the base member 482 and the pivot member 484 to maintain the pivot member 484 at a desired vertical angle relative to the base member 482. In one instance, a second pivot shaft (not illustrated) may pivotally engage the first end 484C of the pivot member 484 with the first end 482C of the base member 482. In this instance, the second pivot shaft is also a connector and/or fastener that is threadably engaged with the first side 482C of the base member 482, via the threaded passageway 482H, and the first side 484C of the pivot member 484, via the first threaded passage 484H1, to enable the pivot member 484 to pivot about a longitudinal axis 486A of the pivot shaft 486. Such inclusion of another pivot shaft may provide structural support between the base member 482 and the pivot member 484 when the pivot member 484 is pivotally moved upwardly and downwardly relative to the base member 482 and when the pivot member 484 is maintained at a desired vertical angle.

During woodworking projects, the pivot shaft 486 enables a woodworker to pivot the pivot member 484 from a range of predetermined angles measured between the top surface 482E of the base member 482 and the bottom surface 484F of the pivot member 484. In the illustrated embodiment, the pivot member 484 is configured to be pivotable from about zero degrees relative to the base member 482 up to about ninety degrees relative to the base member 482.

Still referring to FIG. 15, the accessory 480 also includes at least one attachment mechanism 488 that operably engages the base member 482 with the base table 410 of the joiner jig 300 via the at least one through-hole 482G. The at least one attachment mechanism 488 includes a fastener threadably engaged with a nut in which the nut engages with a T-slot defined in the base table 410 (e.g., T-slots 10G, 10H) for maintaining the accessory 480 at a suitable location relative to the joiner tool 2 and/or the tool mounting assembly 440. In the illustrated embodiment, the accessory 480 includes a first attachment mechanism 488A that operably engages the base member 482 with the base table 410 of the joiner jig 300 via the first through-hole 482G1. Similarly, the accessory 480 includes a second attachment mechanism 488B that operably engages the base member 482 with the base table 410 of the joiner jig 300 via the second through-hole 482G2.

In the illustrated embodiment, the first attachment mechanism 488A and the second attachment mechanism 488B are substantially similar to one another and are engaged with the base member 482 in same orientation. Inasmuch as the first attachment mechanism 488A and the second attachment mechanism 488B are substantially similar to one another, the first attachment mechanism 488A will be described in more detail. It should be understood that while the first attachment mechanism 488A is be described, the description of the first attachment mechanism 488A is identical to the second attachment mechanism 488B.

In the illustrated embodiment, the first attachment mechanism 488A includes a fastener 488A1 that threadably engages with a nut 488A2. The fastener 488A1 and the nut 488A2 are sized and configured to be received by a T-slot of the base table 410 to releasably secure the base member 482 with the base table 410. During a woodworking project, a woodworker would feed the nut 488A2 into a T-slot defined in the base table 410 to engage the base member 482 with the base table 410. The base member 482 is freely moveable along the base table 410 when the nut 488A2 is free from engaging the base table 410 inside of the T-slot. The base member 482 may also be retained at a desired location on the base table 410 when the woodworker tightens and secures the nut 482A2 inside of the T-slot via the fastener 488A1. Similar technique and operation may be used on the second attachment mechanism as well to further releasably secure the base member 482 with the base table 410.

While not illustrated herein, the accessory may include a measurement guide (e.g., a protractor or similar measurement device of the like) to accurately and precisely set the pivot member 484 at a desired vertical angle relative to the base member 482. As such, the measurement guide may be engaged with one or both of the base member 482 and the pivot member 484 to accurately and precisely set the pivot member 484 at a desired vertical angle relative to the base member 482.

Referring to FIG. 16, a woodworker may operably engage the base member 482 at any desired positioned along the base plate 410 via T-slots defined in the base plate 410 via one or both of the first attachment mechanism 488A and the second attachment mechanism 488B. As discussed previously, the base member 482 is freely moveable along the base table 410 when the first attachment mechanism 488A and the second attachment mechanism 488B are disengaged from the base table 410 inside the T-slots. Once the accessory 480 is provided at the desired position on the base plate 410, the base member 482 is secured with the base table 410 when the first attachment mechanism 488A and the second attachment mechanism 488B are engaged with the base table 410 inside the T-slots. In other words, the nut 488A2 of the first attachment mechanism 488A and the nut (not illustrated) of the second attachment mechanism 488B are secured with the base table 410 inside selected T-slots defined in the base table 410.

Once engaged with the base table 410, the woodworker may then pivot the pivot member 484 to a desired vertical angle relative to the base member 482; the desired vertical angle is denoted by double arrows labeled “VA” in FIG. 16. The woodworker must loosen and disengage the pivot shaft 486 from the pivot member 484 until the pivot member 484 is freely pivot about the pivot shaft 486 and relative to the base member 482. At this point, the woodworker may then pivot the pivot member 484 towards and/or away from the base member 482 until the desired vertical angle is met. During this pivoting step, the woodworker may use a separate measuring device, such as a protractor or similar measuring device of the like, to precisely and accurately set the pivot member 484 at the desired vertical angle relative to the base member 482. Once the pivot member 484 is at the desired vertical angle, the woodworker may then tighten the pivot shaft 486 until the pivot shaft 486 engages with the pivot member 484 and the pivot member 484 is maintained at the desired vertical angle.

Once the desired vertical angle is set for the accessory 480, a woodworker may then introduce a workpiece “WP” to the accessory 480. As shown in FIG. 16, a longitudinal face “LF” of the workpiece “WP” rests on and engages with the top surface 484E of the pivot member 484. Once engaged, the workpiece “WP” is maintained at the desired vertical axis by the pivot member 484 of the accessory 480. The woodworker may then drill and/or cut at least one mortise into the workpiece “WP” via the joiner tool 2 operably engaged with the tool mounting assembly 440. During this drilling process, the woodworker may simply grasp the workpiece “WP” against the pivot member 484 to ensure the workpiece “WP” does not shift and/or move transversely along the pivot member 484. Prior to this drilling process, the woodworker may use a clamp and/or similar gripping device to grasp and hold the workpiece “WP” against the pivot member 484 to ensure the workpiece “WP” does not shift and/or move transversely and/or longitudinally along the pivot member 484.

Once the at least one mortise has been drilled into the workpiece “WP”, the woodworker may introduce additional types of workpiece to the accessory 480 in order to cut identical mortises at the desired vertical angle set by the accessory 480. The woodworker may also reset and/or position the pivot member 484 at a different vertical angle relative to the base member 482. As such, the woodworker would repeat the steps as discussed above in order to set a new desired vertical angle for the pivot member 484.

Once the woodworker is no longer is need of the accessory 480, the woodworker may collapse the pivot member 484 until the pivot member 484 surrounds the base member 482 and is coplanar with the base member 482. The woodworker may desire this position when the woodworker is not currently in need of the accessory 480 yet will need to use the accessory 480 later in a woodworking project. The woodworker may also desire to remove the entire accessory 480 from the base table 410 when the woodworker has no need or use for the accessory 480 during a woodworking project. As such, the woodworker would loosen the attachment mechanisms 488A, 488B until the attachment mechanisms 488A, 488B are disengaged from the base table 410 to fully remove the accessory from the base table 410.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A joiner jig, comprising:
a base table adapted to operably engage with a joiner tool;
a fence operably engaged with the base table; and
an adjustable protractor assembly selectively operably engaged with the base table and the fence;
wherein the adjustable protractor assembly is configured to be selectively pivotally adjustable to at least one predetermined angle from a range of angles.

2. The joiner jig of claim 1, the adjustable protractor assembly comprises:
a fixed portion operably engaged with the base table; and
a moveable portion operably engaged with the fixed portion;
wherein the moveable portion is configured to be selectively pivotally adjustable to the at least one predetermined angle from the range of angles relative to the fixed portion.

3. The joiner jig of claim 2, wherein the range of angles is from about 45 degrees up to about 90 degrees.

4. The joiner jig of claim 2, the adjustable protractor assembly further comprises:
a spacing gauge operably engaged with the fixed portion;
wherein the spacing gauge is adapted to engage a drill stop of the joiner tool to set the adjustable protractor assembly at a predetermined distance away from the joiner tool from a range of distances enabled by the spacing gauge.

5. The joiner jig of claim 4, wherein the adjustable protractor assembly further comprises:
at least one locking aperture defined in the fixed portion;
a through-slot defined in the spacing gauge; and
at least one connector operably engaged with the fixed portion, via the at least one locking aperture, and the spacing gauge, via the through-slot for selectively securing the spacing gauge with the fixed portion.

6. The joiner jig of claim 5, wherein when the at least one connector engages both the fixed portion and the spacing gauge, the spacing gauge is secured with the fixed portion at a predetermined position; and
wherein when the at least one connector engages the fixed portion and disengages the spacing gauge, the spacing gauge is freely moveable along the fixed portion.

7. The joiner jig of claim 2, wherein the base table further comprises:
at least one set of adjustment threaded openings defined in the base table;
wherein the adjustable protractor assembly is selectively positionable on the base table via the at least one set of adjustment threaded openings.

8. The joiner jig of claim 7, wherein the adjustable protractor assembly further comprises:
an adjustment slot defined in the fixed portion; and
a locking knob selectively engaged with the fixed portion and one of the at least one set of adjustment threaded openings for maintaining the adjustable protractor assembly at a range of predetermined positions along the base table.

9. The joiner jig of claim 8, wherein when the locking knob engages both the fixed portion and one of the at least one set of adjustment threaded openings, the adjustable protractor assembly is secured at a predetermined position from the range of predetermined positions on the base table; and
wherein when the locking knob disengages the fixed portion and engages one of the at least one set of adjustment threaded openings, the adjustable protractor assembly is freely moveable along the base table.

10. The joiner jig of claim 1, wherein the base table further comprises:
at least one longitudinal T-shaped slot defined in the base table; and
at least one transverse T-Shaped slot defined in the base table;
wherein each of the at least one longitudinal T-shaped slot and the at least one transverse T-Shaped slot is adapted to receive at least one track clamp to enable the at least one track clamp and the base table to engage one another.

11. The joiner jig of claim 1, further comprising:
a tool mounting assembly operably engaged with the base table;
wherein the tool mounting assembly is adapted to operably engaged with the joiner tool to vertically move the joiner tool relative to the base table.

12. The joiner jig of claim 11, wherein the tool mounting assembly comprises:
a base plate operably engaged with the base table;
at least one riser operably engaged with the base plate and extending from the base plate;
a mount plate operably engaged with the at least one riser and moveable along the at least one riser; and
at least one tube post operably engaged with the at least one riser and configured to receive the at least one riser;
wherein the mount plate and the at one tube post are selectively secured at a desired position along the at least one riser relative to the base plate.

13. The joiner jig of claim 12, wherein the tool mounting assembly further comprises:
a locking knob selectively engaged with the at least one riser and the at least one tube post;
wherein when the locking knob is engaged with both the at least one riser and the at least one tube post, the mount plate and the at least one tube post are maintained at the desired position on the at least one riser;
wherein when the locking knob is disengaged with the at least one riser and engaged the at least one tube post, the mount plate and the at least one tube post are freely moveably along the at least one riser.

14. The joiner jig of claim 12, wherein the tool mounting assembly further comprises:
at least one biaser operably engaged with the at least one riser and the at least one tube post;
wherein the at least one biaser biases the at least one tube post and the mount plate away from the at least one riser.

15. The joiner jig of claim 12, wherein the tool mounting assembly further comprises:
at least one height limiting assembly operably engaged with the base plate and the mount plate;
wherein the at least one height limiting assembly is configured to restrict vertical movement of the mount plate relative to the base plate.

16. The joiner jig of claim 1, further comprising:
an accessory releasably secured with the base plate;
wherein the accessory is configured to hold a workpiece at a desired vertical angle relative to the joiner tool.

17. A method of drilling at least one mortise into a workpiece with a joiner jig, comprising steps of:
engaging a joiner tool with a tool mounting assembly of the joiner jig;
engaging an adjustable protractor assembly of the joiner jig at a predetermined position with a base table of the joiner jig;
positioning the adjustable protractor assembly at a predetermined distance relative to a drill bit of the joiner tool;
setting a moveable portion of the adjustable protractor assembly of the joiner jig to a predetermined angle relative to a fixed portion of the adjustable protractor assembly;
engaging the workpiece with the moveable portion of the adjustable protractor assembly; and
drilling at least one mortise into the workpiece.

18. The method of claim 17, further comprising:
setting a spacing gauge of the adjustable protractor assembly to space the adjustable protractor assembly at a distance away from the joiner jig.

19. The method of claim 17, further comprising:
disengaging a locking knob of the tool mounting assembly from at least one riser of the tool mounting assembly;
moving at least one tube post of the tool mounting assembly and a mount plate of the tool mounting assembly along the at least one riser to a desired position relative to the base table, wherein the joiner tool is operably engaged with the mount plate;
engaging the locking knob with the at least one riser to maintain the mount plate at the desired position relative to the base table.

20. The method of claim 17, further comprising:
positioning the adjustable protractor assembly in a first orientation relative to the base table;
positioning the adjustable protractor assembly in a second orientation relative to the base table;
wherein the second orientation is a mirrored orientation of the first orientation.

21. The method of claim 17, further comprising:
disengaging an adjustment dial of the adjustable protractor assembly from an adjustment plate of the adjustable protractor assembly;
pivoting the moveable portion away from the fixed portion to the predetermined angle; and
reengaging the adjustment dial with the adjustment plate to maintain the predetermined angle.
